(19) United States
(12) Patent Application Publication
(10) Pub. No.: US 2026/0188115 A1
(43) Pub. Date: Jul. 2, 2026

(54) SYSTEM AND METHOD ON THE ROAD INFRASTRUCTURE FOR CONTROLLING CONNECTED AND AUTONOMOUS VEHICLES

(71) Applicant: Technology Innovation Institute - Sole Proprietorship LLC, Masdar City (AE)

(72) Inventors: Zine el abidine Kherroubi, Abu Dhabi (AE); Fouzi Boukhalfa, Abu Dhabi (AE)

(73) Assignee: Technology Innovation Institute - Sole Proprietorship LLC, Masdar City (AE)

(21) Appl. No.: 19/419,874

(22) Filed: Dec. 15, 2025

Related U.S. Application Data
(60) Provisional application No. 63/739,276, filed on Dec. 27, 2024.

(51) Int. Cl. G08G 1/0967; B60W 40/04; B60W 40/105; B60W 50/00; B60W 60/00; G08G 1/01

(52) U.S. Cl. CPC G08G 1/096725; B60W 40/04; B60W 40/105; B60W 50/0098; B60W 60/00272; G08G 1/0116; B60W 2050/0028; B60W 2510/20; B60W 2520/10; B60W 2520/105; B60W 2552/05; B60W 2552/10; B60W 2554/4045; B60W 2554/4046; B60W 2556/35; B60W 2556/45; B60W 2710/20; B60W 2720/10; B60W 2720/106

(57) ABSTRACT

A system for controlling an autonomous vehicle using road infrastructure, comprising a plurality of sensors mounted on road infrastructure sensing information on a roadway, a fusion module fusing the sensed information from the plurality of sensors to detect vehicles on the roadway, a features extraction module extracting features from the detected vehicles, a driver intention model providing estimated driving behavior of manually driven vehicles of the detected vehicles based on the extracted features, a deep reinforcement learning module providing control actions for the autonomous vehicle based on the estimated driving behavior of the manually driven vehicles of the detected vehicles and based on the extracted features, a reference trajectory generation module extrapolating planned trajectories of the autonomous vehicle based on the control actions, and a V2X module for transmitting instructions to the autonomous vehicle based on the planned trajectories.

### CROSS-REFERENCE TO RELATED APPLICATIONS

This application claims priority to U.S. Provisional Patent Application No. 63/739,276, filed Dec. 27, 2024, which is incorporated by reference in its entirety.

### FIELD

The present disclosure relates to autonomous vehicle control systems, and more particularly to a system and method for controlling connected and autonomous vehicles using road infrastructure-based sensors, data fusion, and machine learning algorithms.

### BACKGROUND

Autonomous vehicles have gained significant attention in recent years as a promising technology to improve road safety and transportation efficiency. These vehicles rely on a combination of onboard sensors, advanced algorithms, and artificial intelligence to navigate roads and make driving decisions. Current autonomous driving systems typically use cameras, LiDAR, radar, and other sensors mounted on the vehicle itself to perceive the surrounding environment. This data is then processed by onboard computers to detect objects, predict their movements, and plan the vehicle's trajectory.

However, existing autonomous vehicle systems face several limitations. The perception range and accuracy of onboard sensors can be restricted due to factors such as line-of-sight limitations, blind spots, and the physical constraints of mounting sensors on a moving vehicle. Additionally, the computational power available in vehicles is often limited compared to the complex algorithms required for safe autonomous driving. Furthermore, the coexistence of autonomous and human-driven vehicles on the same roads presents challenges in predicting and responding to the behavior of human drivers. These limitations can potentially impact the safety and efficiency of autonomous vehicles, particularly in complex traffic scenarios such as highway merging or navigating through busy intersections.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, the present disclosure relates to a system for controlling an autonomous vehicle using road infrastructure, comprising a plurality of sensors mounted on road infrastructure sensing information on a roadway, a fusion module fusing the sensed information from the plurality of sensors to detect vehicles on the roadway, a features extraction module extracting features from the detected vehicles, a driver intention model (DIM) providing estimated driving behavior of manually driven vehicles of the detected vehicles based on the extracted features, a deep reinforcement learning (DRL) module providing control actions for the autonomous vehicle based on the estimated driving behavior of the manually driven vehicles of the detected vehicles and based on the extracted features, a reference trajectory generation module extrapolating planned trajectories of the autonomous vehicle based on the control actions, and a V2X module for transmitting instructions to the autonomous vehicle based on the planned trajectories.

In embodiments of this aspect, the disclosure according to any one of the above example embodiments, the system further comprising a safe controller for verifying the control actions provided by the DRL module against predefined safety rules, a features correction module for compensating for errors in the extracted features based on a deviation between an actual state of the autonomous vehicle and the planned trajectories, a recommendation calculator for calculating at least one of recommended speeds or recommended steering for the autonomous vehicle as part of the instructions.

In embodiments of this aspect, the disclosure according to any one of the above example embodiments, the system further comprising a monitoring module for checking a state of traffic and selecting appropriate parameters for the DIM and the DRL module based on detected traffic conditions.

In embodiments of this aspect, the disclosure according to any one of the above example embodiments, the DIM is trained using supervised or unsupervised learning to predict driver behaviors of the manually driven vehicles, and wherein the DIM outputs a probability indicating a likelihood of a highway driver yielding to a merging vehicle.

In embodiments of this aspect, the disclosure according to any one of the above example embodiments, the DRL module receives as input the extracted features and an output of the DIM, and generates recommended acceleration, deceleration or steering actions for the autonomous vehicle based on the inputs.

In embodiments of this aspect, the disclosure according to any one of the above example embodiments, the reference trajectory generation module compensates for uncertainties in vehicle dynamic models, lags in vehicle control and reinforcement learning transferability bias by extrapolating the planned trajectories according to the actions provided by the DRL and a safety controller.

In embodiments of this aspect, the disclosure according to any one of the above example embodiments, the features correction module adjusts the extracted features for the DIM and the DRL module based on deviations between an actual state of the autonomous vehicle and a desired reference trajectory, and wherein the adjustment comprises adding corrective terms to the extracted features.

In embodiments of this aspect, the disclosure according to any one of the above example embodiments, the system further comprising a speed and steering recommendation safety check module for monitoring whether the autonomous vehicle can track a provided reference trajectory, wherein the monitoring comprises comparing a current state of the autonomous vehicle to the reference trajectory at predetermined time intervals.

In embodiments of this aspect, the disclosure according to any one of the above example embodiments, the speed and steering recommendation safety check module generates a Minimum Risk Maneuver when a deviation between a state of the autonomous vehicle and a reference trajectory exceeds a predefined threshold, and wherein the Minimum Risk Maneuver comprises safe instructions for the autonomous vehicle to safely decelerate and pull over to a designated safe zone.

In embodiments of this aspect, the disclosure according to any one of the above example embodiments, the V2X module transmits Maneuver Coordination Messages containing the instructions comprising speed recommendations, steering recommendations, acceleration profiles, and anticipated merge points for the autonomous vehicle.

In one aspect, the present disclosure relates to a method for controlling an autonomous vehicle using road infrastructure, comprising sensing information on a roadway using a plurality of sensors mounted on road infrastructure, fusing the sensed information from the plurality of sensors to detect vehicles on the roadway, extracting features from the detected vehicles, providing estimated driving behavior of manually driven vehicles of the detected vehicles based on the extracted features using a DIM, providing control actions for the autonomous vehicle based on the estimated driving behavior of the manually driven vehicles of the detected vehicles and based on the extracted features using a DRL module, extrapolating planned trajectories of the autonomous vehicle based on the control actions, and transmitting instructions to the autonomous vehicle based on the planned trajectories using a V2X module.

In embodiments of this aspect, the disclosure according to any one of the above example embodiments, the method further comprising verifying the control actions provided by the DRL module against predefined safety rules using a safe controller, compensating for errors in the extracted features based on a deviation between an actual state of the autonomous vehicle and the planned trajectories using a features correction module, calculating at least one of recommended speeds or recommended steering for the autonomous vehicle as part of the instructions using a recommendation calculator.

In embodiments of this aspect, the disclosure according to any one of the above example embodiments, the method further comprising checking a state of traffic and selecting appropriate parameters for the DIM and the DRL module based on detected traffic conditions using a monitoring module.

In embodiments of this aspect, the disclosure according to any one of the above example embodiments, the DIM is trained using supervised or unsupervised learning to predict driver behaviors of the manually driven vehicles, and wherein the DIM outputs a probability indicating a likelihood of a highway driver yielding to a merging vehicle.

In embodiments of this aspect, the disclosure according to any one of the above example embodiments, the DRL module receives as input the extracted features and an output of the DIM, and generates recommended acceleration, deceleration or steering actions for the autonomous vehicle based on the inputs.

In embodiments of this aspect, the disclosure according to any one of the above example embodiments, extrapolating the planned trajectories comprises compensating for uncertainties in vehicle dynamic models, lags in vehicle control and reinforcement learning transferability bias by extrapolating the planned trajectories according to the actions provided by the DRL and a safety controller.

In embodiments of this aspect, the disclosure according to any one of the above example embodiments, compensating for errors in the extracted features comprises adjusting the extracted features for the DIM and the DRL module based on deviations between an actual state of the autonomous vehicle and a desired reference trajectory, and wherein the adjustment comprises adding corrective terms to the extracted features.

In embodiments of this aspect, the disclosure according to any one of the above example embodiments, the method further comprising monitoring whether the autonomous vehicle can track a provided reference trajectory using a speed and steering recommendation safety check module, wherein the monitoring comprises comparing a current state of the autonomous vehicle to the reference trajectory at predetermined time intervals.

In embodiments of this aspect, the disclosure according to any one of the above example embodiments, the method further comprising generating a Minimum Risk Maneuver when a deviation between a state of the autonomous vehicle and a reference trajectory exceeds a predefined threshold using the speed and steering recommendation safety check module, and wherein the Minimum Risk Maneuver comprises safe instructions for the autonomous vehicle to safely decelerate and pull over to a designated safe zone.

In embodiments of this aspect, the disclosure according to any one of the above example embodiments, transmitting instructions comprises transmitting Maneuver Coordination Messages containing the instructions comprising speed recommendations, steering recommendations, acceleration profiles, and anticipated merge points for the autonomous vehicle.

The foregoing general description of the illustrative embodiments and the following detailed description thereof are merely exemplary aspects of the teachings of this disclosure and are not restrictive.

### BRIEF DESCRIPTION OF THE DRAWINGS

So that the way the above-recited features of the present disclosure can be understood in detail, a more particular description of the disclosure, briefly summarized above, may be made by reference to example embodiments, which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 illustrates a block diagram of a system for controlling autonomous vehicles using road infrastructure, according to aspects of the present disclosure.

FIG. 2 illustrates a system for controlling autonomous vehicles using road infrastructure in a merge scenario, according to an embodiment.

FIG. 3 illustrates a block diagram of a system for controlling connected and autonomous vehicles using road infrastructure, according to aspects of the present disclosure.

FIG. 4A illustrates a flowchart for a process of controlling an autonomous vehicle using road infrastructure, according to an embodiment.

FIG. 4B illustrates a flowchart for a process of collecting and processing sensor data for autonomous vehicle control, according to aspects of the present disclosure.

FIG. 4C illustrates a flowchart for a process of generating and verifying recommended actions for a connected autonomous vehicle, according to an embodiment.

FIG. 4D illustrates a flowchart for a process of adjusting input features for machine learning models in a vehicle control system, according to aspects of the present disclosure.

FIG. 4E illustrates a flowchart for a process of generating and verifying trajectory recommendations for a connected autonomous vehicle, according to an embodiment.

FIG. 4F illustrates a flowchart for a process of generating and transmitting Maneuver Coordination Messages to a connected autonomous vehicle, according to aspects of the present disclosure.

FIG. 5 illustrates a proof of concept block diagram of a system for controlling autonomous vehicles using road infrastructure in a 1:18 scale model experiment, according to an embodiment.

FIG. 6A illustrates a flowchart for a proof of concept process of controlling autonomous vehicles using roadside infrastructure in a 1:18 scale model experiment, according to aspects of the present disclosure.

FIG. 6B illustrates a diagram of proof of concept trials for controlling autonomous vehicles using road infrastructure in a 1:18 scale model experiment, according to an embodiment.

FIG. 6C illustrates a diagram of proof of concept trials for controlling autonomous vehicles using road infrastructure in a 1:18 scale model experiment, according to aspects of the present disclosure.

FIG. 6D illustrates a graph comparing different trajectory generation methods for a vehicle for proof of concept in a 1:18 scale model experiment, according to an embodiment.

FIG. 6E illustrates a graph comparing different trajectory generation methods for a vehicle for proof of concept in a 1:18 scale model experiment, according to an embodiment.

### DETAILED DESCRIPTION

Various example embodiments of the present disclosure will now be described in detail with reference to the drawings. It is noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

The present disclosure provides a system and method for controlling connected autonomous vehicles (CAVs) of various levels of autonomy (e.g. conditional driving automation, high driving automation and full driving automation, etc.) using an off-board road infrastructure. This system may leverage the advantages of infrastructure-based sensors and edge computing devices to enhance the perception range, improve accuracy, and increase computational power for autonomous driving.

It is noted that in aspects, the CAVs controlled by the disclosed system and methods may be defined as being fully autonomous or semi-autonomous, capable of operating with varying degrees of human intervention. For fully autonomous vehicles, the system may provide comprehensive control instructions, including detailed trajectory planning and decision-making for complex scenarios. In the case of semi-autonomous vehicles, the system may offer advisory information or partial control, allowing for human override or intervention. The flexibility of the system to accommodate both types of vehicles may enable a smoother transition in mixed traffic environments, where varying levels of autonomy coexist on the same roadways.

The system employs a hybrid machine learning approach that combines a driver intention model (DIM) and a deep reinforcement learning (DRL) agent to predict human driver behavior and generate control actions for CAVs, respectively. This approach allows for sophisticated and adaptive decision-making, particularly in mixed traffic environments where autonomous and human-driven vehicles (HDVs) coexist.

The system may also include auxiliary components such as a safe controller, a reference trajectory generation module, and a features correction module. These components may contribute to the robustness and safety of the system by verifying the safety of control actions, compensating for uncertainties in vehicle dynamics, and correcting potential errors in the inputs to the machine learning models.

Furthermore, the system may incorporate a monitoring module that adapts to changing traffic conditions by selecting appropriate DIM and DRL models. This adaptability may enhance the system's performance across different traffic scenarios.

The system and method for controlling CAVs using off-board road infrastructure may have various use cases. In urban environments, the system may assist with complex intersections, managing traffic flow during peak hours, and coordinating vehicle movements in areas with high pedestrian activity. On highways, it may facilitate safer and more efficient merging, lane changes, and exit maneuvers. The system may also be useful in managing traffic around construction zones, adapting to temporary road closures or detours. In parking facilities, it may optimize space utilization and guide vehicles to available spots. During adverse weather conditions, the system may provide enhanced guidance and safety measures. Additionally, it may be beneficial for coordinating autonomous vehicle fleets for ride-sharing or delivery services, and for managing traffic flow around large events or emergency situations.

In specific use cases such as highway on-ramp merging, the system can effectively manage complex traffic situations by predicting the behavior of highway drivers and providing appropriate speed and/or steering recommendations for the merging CAV. This approach can potentially prevent collisions and optimize traffic flow, demonstrating the system's potential to improve safety and efficiency in challenging traffic scenarios.

Overall, the system and method disclosed herein offer a comprehensive solution for controlling CAVs using road infrastructure, addressing the limitations of current onboard autonomous driving systems and enhancing the safety and efficiency of autonomous driving.

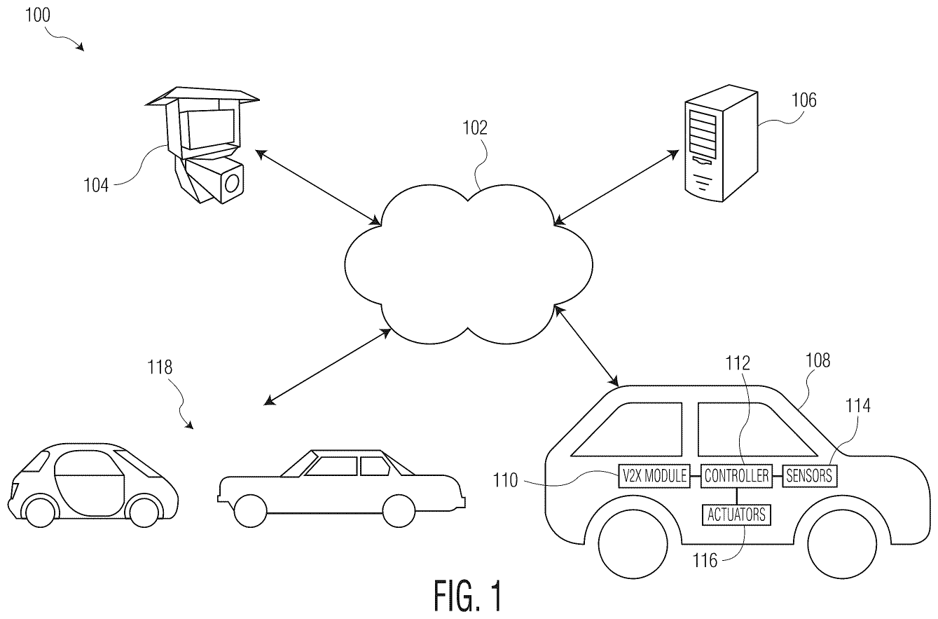

Referring to FIG. 1, a block diagram illustrates an example of a system 100 for controlling CAVs using road infrastructure. The system 100 in FIG. 1 may include a network 102, road-side sensor 104, server 106, and a heterogeneity based driving environment with CAV 108 with a V2X module 110, controller 112, sensors 114, actuators 116, and multiple vehicles 118 which may be autonomous or may be manually driven vehicles.

More specifically, the system 100 may include a network 102 that facilitates communication between various components. A road-side sensor 104 may be positioned to monitor road conditions and vehicle movements. The sensor 104 may be connected to the network 102, allowing it to transmit collected data.

A server 106 may be also connected to the network 102. This server 106 processes data from the road-side sensor 104 and generates control instructions for CAVs. The system 100 may include CAV 108 equipped with a V2X module 110 for vehicle-to-everything communication. The V2X module 110 enables the vehicle 108 to receive instructions from the server 106 via the network 102.

Inside the vehicle 108, a controller 112 (e.g., device including a processor, memory, etc.) may be connected to the V2X module 110. The controller 112 interprets instructions received from the server 106 and manages the vehicle's functions. The vehicle 108 may be also equipped with sensors 114 that provide local environmental data to the controller 112. Actuators 116 may be connected to the controller 112, allowing it to control the vehicle's movements based on received instructions and sensor data.

The system 100 may be designed to operate in an environment with multiple vehicles 118, which may include both autonomous and non-autonomous vehicles. These vehicles 118 may be monitored by the road-side sensor 104, and their presence and behavior influence the instructions generated by the server 106 for the CAV 108.

In aspects, the system 100 may include additional or different components. For example, the system 100 may include multiple road-side sensors 104 positioned at various locations along the roadway. These sensors 104 may include different types of sensors, such as cameras, LiDAR sensors, radar sensors, or other types of sensors suitable for detecting vehicles and road conditions. The server 106 may include one or more processors and memory storing instructions for processing sensor data and generating control instructions. The vehicle 108 may include additional or different autonomous functions, such as navigation, obstacle detection, or other functions. The network 102 may include wired or wireless connections, and may include one or more networks, such as a local area network (LAN), a wide area network (WAN), the Internet, or other types of networks.

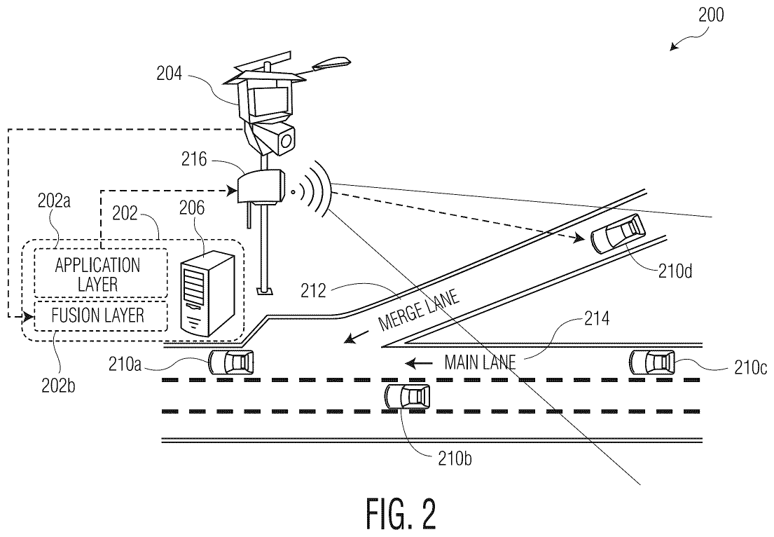

Referring to FIG. 2, a system 200 for controlling CAVs such as vehicle 108 using road infrastructure is illustrated. The system 200 in FIG. 2 may include a roadside unit 202 that may include road-side sensors 204 for collecting data from the roadway, V2X module 216 for facilitating communication, and an edge computer 206 for processing the data. FIG. 2 also shows a merging vehicle 210d, main lane vehicles 210a, 210b, and 210c, a merge lane 212, and a main lane 214.

More specifically, system 200 may include a roadside unit 202 positioned near a roadway. The roadside unit 202 may include road-side sensors 204 for detecting vehicles and an edge computer 206 for processing sensor data and controlling CAVs. In aspects, the coverage area of the roadside unit 202 may be influenced by factors such as line-of-sight (LoS) and non-line-of-sight (NLoS) conditions, field of view (FoV), sensor orientation, and the height at which the sensors are mounted. These factors may affect the ability of the road-side sensors 204 to detect and track vehicles in different parts of the roadway.

In aspects, the road-side sensors 204 may include a variety of sensor types, such as cameras, LiDAR sensors, radar sensors, or other types of sensors suitable for detecting vehicles and road conditions. These sensors 204 may be mounted on the road infrastructure and may be positioned to detect vehicles in both the main lane 214 and merge lane 212. The sensors 204 communicate with the edge computer 206, as indicated by the dashed line. The edge computer 206 also communicates with V2X module 216, as indicated by the dashed line.

The edge computer 206 contains an application layer 202a and a fusion layer 202b. The fusion layer 202b receives and fuses data from the road-side sensors 204. The application layer 202a processes the fused sensor data to control CAVs.

The roadway may include a main lane 214 and a merge lane 212. Several vehicles are shown on the roadway, including main lane vehicles 210a, 210b, and 210c traveling on the main lane 214. The system 200 enables the roadside unit 202 to monitor traffic conditions using the road-side sensors 204 and edge computer 206. This allows the system to assist CAVs with tasks such as merging from the merge lane 212 into the main lane 214 by providing sensor data and control instructions.

In cases, the system 200 may include additional or different components. For example, the system 200 may include multiple road-side sensors 204 positioned at various locations along the roadway. These sensors 204 may include different types of sensors, such as cameras, LiDAR sensors, radar sensors, or other types of sensors suitable for detecting vehicles and road conditions. The edge computer 206 may include one or more processors and memory storing instructions for processing sensor data and generating control instructions. The network 102 may include wired or wireless connections, and may include one or more networks, such as a local area network (LAN), a wide area network (WAN), the Internet, or other types of networks.

In aspects, the system may monitor main lane vehicles to determine if they are aggressive drivers or not and then control the merging vehicle accordingly. The road-side sensors may collect data on the speed, acceleration, and lane-changing behavior of vehicles in the main lane. This data may be processed by the DIM to classify drivers as aggressive or non-aggressive. If an aggressive driver is detected in the main lane near a merging point, the DRL module may generate more conservative control actions for the merging CAV. For instance, the system may instruct the CAV to slow down and wait for a larger gap or to merge behind the aggressive driver rather than attempting to merge in front. Conversely, if non-aggressive drivers are detected, the system may generate more assertive merging instructions for the CAV. This adaptive approach may help to reduce the risk of collisions and improve overall traffic flow by tailoring the merging strategy to the current behavior of human drivers in the main lane.

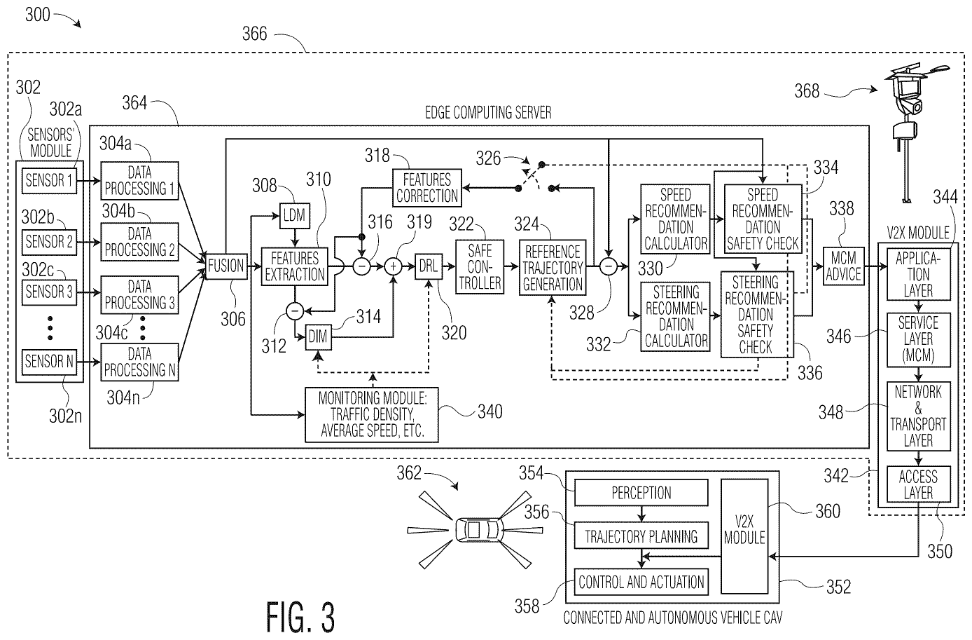

Referring to FIG. 3, a block diagram illustrates a system 300 including a roadside system 366 for controlling CAVs 362 using road infrastructure. System 300 may be implemented on various devices including roadside sensors, edge computers, servers, V2X modules, etc.

FIG. 3 illustrates a system 300 that may include a roadside unit 366 that may include a sensors module 302 with multiple sensors 302a-n, and an edge computing server 364 with data processing modules 304a-n, a fusion module 306, a Local Dynamic Map (LDM) module 308, a DIM 314, a features extraction module 310, difference modules 312 and 316, a features correction module 318, a summation module 319, a DRL module 320, a safe controller 322, a reference trajectory generation module 324, a switch 326, a difference module 328, speed and/or steering recommendation calculators 330 and 332, safety check modules 334 and 336, a Maneuver Coordination Messages (MCM) advice module 338, a monitoring module 340. Roadside unit 366 may also include a V2X module 342 and with multiple layers 344-350, a CAV 352 with modules perception module 354, trajectory planning module 356, control and actuation module 358 and V2X module 360. CAV 362, and road-side sensors 368 are also shown.

More specifically, the system 300 may include a sensors module 302 comprising multiple sensors 302a, 302b, 302c, up to 302n. Each sensor may be connected to a corresponding data processing module 304a, 304b, 304c, up to 304n. In aspects, the sensors 302a, 302b, 302c, up to 302n may include various types of sensors mounted on the road infrastructure, such as cameras, LiDAR sensors, radar sensors, or other types of sensors suitable for detecting vehicles and road conditions. The data processing modules 304a, 304b, 304c, up to 304n may include various data processing methods for each sensor, such as you only look once (YOLO) framework for cameras, clustering pointpillars for LiDAR, or other suitable data processing methods. This preprocessing may also be performed on the sensors' edge. It is noted that the sensors and data processing may be designed to satisfy a detection accuracy threshold.

The outputs from the data processing modules may be fed into a fusion module 306. The fusion module 306 combines the processed data from each sensor to provide detected objects from perception features of each individual sensor. This fused data may be then used to create a unified environmental model and update a LDM.

The system 300 further may include a features extraction module 310 that extracts features from the detected objects. These extracted features may be then input to a DIM 314. The DIM 314 may be a machine learning model that provides an estimation of human driver behaviors, such as the intention to yield or not yield during a merging scenario. The DIM 314 may be trained using supervised or unsupervised learning methods.

The output from the DIM 314 and the extracted features may be combined and input to a DRL module 320. The DRL module 320 generates control actions for the CAVs based on the current traffic situation and the output from the DIM 314. The DRL module 320 may be responsible for making sophisticated and adaptive decisions for the CAVs, such as determining appropriate speed recommendations for merging.

The system 300 may include a safe controller 322 that verifies the control actions provided by the DRL module 320 against predefined safety rules. In cases, the safe controller 322 may replace unsafe actions with safe alternatives to ensure the overall safety of the system. This feature enhances the robustness of the system and ensures that the actions provided by the DRL module 320 are safe for the CAV to execute.

The system 300 also may include a reference trajectory generation module 324. This module extrapolates the planned trajectories of the CAV based on the control actions provided by the DRL module 320 and the safe controller 322. In aspects, the reference trajectory generation module 324 compensates for uncertainties in vehicle dynamics models and lags in the control of the vehicle which helps address the “reinforcement learning transferability” problem when moving from simulated to real-world environments. This feature allows the system to provide strategic control for the CAV and adapt to real-world driving conditions.

The system 300 further may include a speed recommendation calculator 330 and a steering recommendation calculator 332. These calculators calculate recommended speeds or steering for the CAV as part of the instructions based on the CAV's current state and the reference trajectory. In cases, the speed recommendation calculator 330 and the steering recommendation calculator 332 may calculate other control recommendations, such as acceleration or deceleration, based on the output from DRL module and safe controller.

The system 300 also may include a speed recommendation safety check module 334 and a steering recommendation safety check module 336. These modules monitor whether the CAV can track the provided reference trajectory. In aspects, the monitoring may include comparing the current state of the CAV to the reference trajectory at predetermined time intervals. If the deviation between the CAV's projected path and the reference trajectory exceeds a predefined threshold, the system may generate a Minimum Risk Maneuver (MRM) (e.g. slowing down, pulling the vehicle over to the side of the road, etc.) and deactivate the features correction module 318 and reset the reference trajectory generation module 324.

The system 300 may include an MCM advice module 338 that may generate MCMs based on the outputs from the speed and/or steering recommendation calculators and safety check modules. These MCMs may contain detailed instructions for the CAV, including speed recommendations, steering recommendations, acceleration profiles, and anticipated merge points. The MCM advice module 338 may format these instructions into standardized messages that can be efficiently transmitted to the CAV through the V2X communication system, enabling real-time coordination and control of the vehicle's movements in complex traffic scenarios.

The system 300 further may include a V2X module 342 for transmitting instructions to the CAV based on the planned trajectories. The V2X module 342 may include multiple layers, such as an application layer 344, a service layer 346, a network and transport layer 348, and an access layer 350. These layers facilitate the formatting, processing, and transmission of the instructions to the CAV. The instructions may include speed recommendations, steering recommendations, acceleration profiles, and anticipated merge points for the CAV. The V2X module 342 enables the system to communicate with the CAV and provides it with real-time control instructions, enhancing the safety and efficiency of autonomous driving. It is noted that the Vehicle-to-Everything (V2X) module may use various communication technologies including, but not limited to, Dedicated Short Range Communications (DSRC), Long-Term Evolution Vehicle-to-Everything (LTE-V2X), and 5th Generation New Radio (5G NR). The V2X technology employed may also meet certain Quality of Service (QoS) thresholds to ensure reliable and efficient communication between vehicles and infrastructure. These QoS thresholds may include parameters such as latency, bandwidth, and reliability, which are important for the timely and accurate exchange of information in CAV control systems.

Continuing with the description of the system 300 as shown in FIG. 3, the system may include a features correction module 318. In aspects, the features correction module 318 compensates for errors that may be incorporated into the inputs of the AI models when the state of a CAV deviates from the desired reference trajectory. This deviation may be due to various factors, such as uncertainties and non-linearities of vehicle dynamic models, control lags, and reinforcement learning transferability bias. The features correction module 318 improves the robustness of the AI models' outputs by adjusting the extracted features for the DIM 314 and DRL 320 modules based on the deviation. This adjustment may include adding corrective terms to the extracted features.

In aspects, the activation or deactivation of the features correction module 318 may be controlled by the speed recommendation safety check module 334 and the steering recommendation safety check module 336 via the switch 326. The switch 326 may act as a control mechanism that enables or disables the features correction module 318 based on the safety assessments performed by these modules. When the safety check modules determine that the CAV's projected path aligns closely with the reference trajectory, they may signal the switch 326 to activate the features correction module 318, allowing it to fine-tune the input features. However, if the safety check modules detect a significant deviation that exceeds predefined thresholds, they may instruct the switch 326 to deactivate the features correction module 318. This dynamic activation/deactivation mechanism may help maintain system stability and prevent potential compounding of errors in situations where the vehicle's state has deviated substantially from the expected trajectory.

In aspects, the speed recommendation safety check module 334 and the steering recommendation safety check module 336 may reset the planned trajectory generated by the reference trajectory generation module 324 to align with the CAV's current projected path. This reset mechanism may be triggered when these safety check modules detect a significant deviation between the CAV's projected path and the reference trajectory that exceeds predefined thresholds. The reset process may serve as a control mechanism based on the safety assessments performed by these modules. By aligning the planned trajectory with the vehicle's current projected path, the system may adapt to unexpected changes in the vehicle's state or environment. This dynamic reset mechanism may help maintain system stability and prevent potential compounding of errors, particularly in situations where the vehicle's state has deviated substantially from the expected trajectory. By realigning the planned trajectory with the vehicle's actual path, the system may improve its ability to generate accurate and relevant control recommendations, potentially enhancing the overall safety and efficiency of the CAV's operation.

The system 300 further may include a monitoring module 340. In cases, the monitoring module 340 checks the state of traffic, such as traffic density and average speed, and selects appropriate parameters for the DIM 314 and DRL 320 modules based on the detected traffic conditions. This adaptability enhances the system's performance across different traffic scenarios. The monitoring module 340 compensates for the generalization issue of AI models by selecting appropriate DIM and DRL models that were trained according to the detected traffic's state.

The DIM 314 may be a machine learning model that provides an estimation about human drivers' behaviors, such as the intention to yield or not yield during a merging scenario. The DIM 314 may be trained using supervised or unsupervised learning methods. The output from the DIM 314, along with the extracted features from the features extraction module 310, may be combined and input to the DRL 320 module.

The system 300 also may include a LDM 308 that provides information on the driving location geometry. The LDM 308 may be updated with the fused data from the fusion module 306. The LDM 308 can provide beneficial context for the AI models, helping them to understand the current traffic situation and make more accurate predictions and decisions.

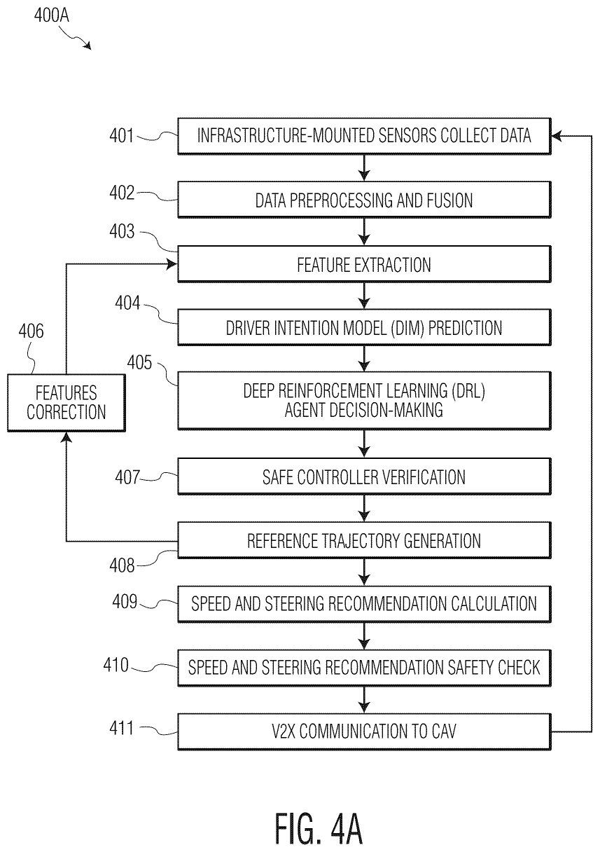

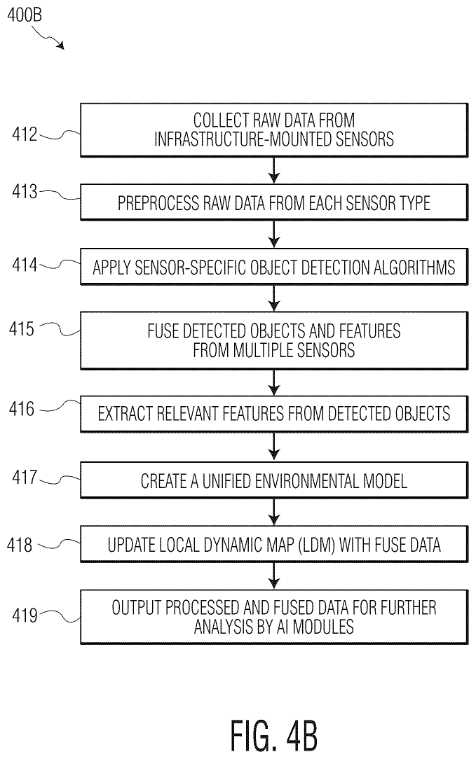

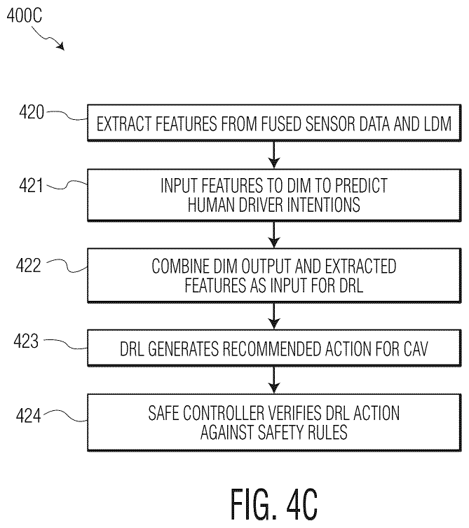

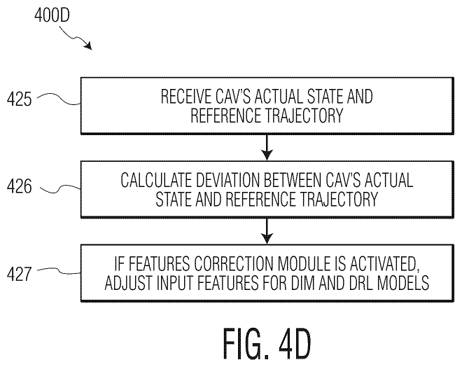

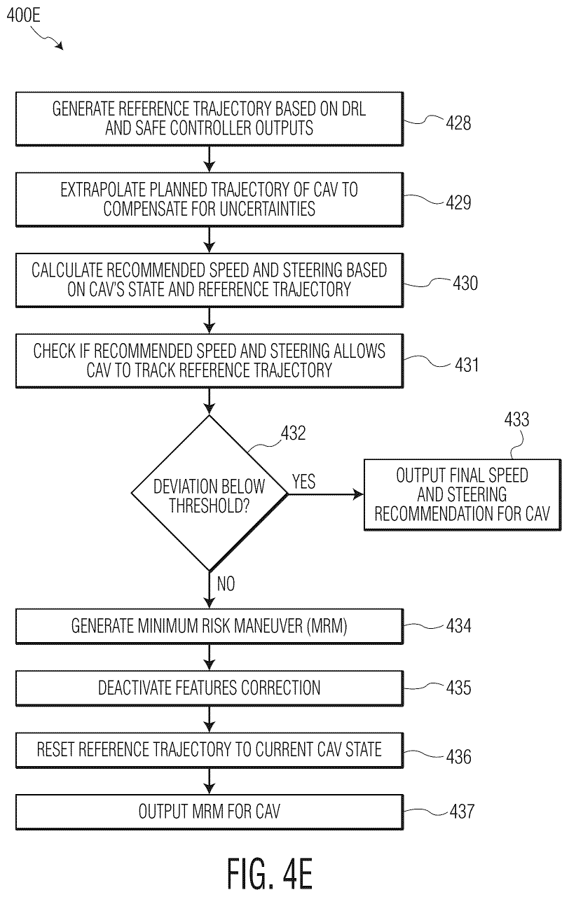

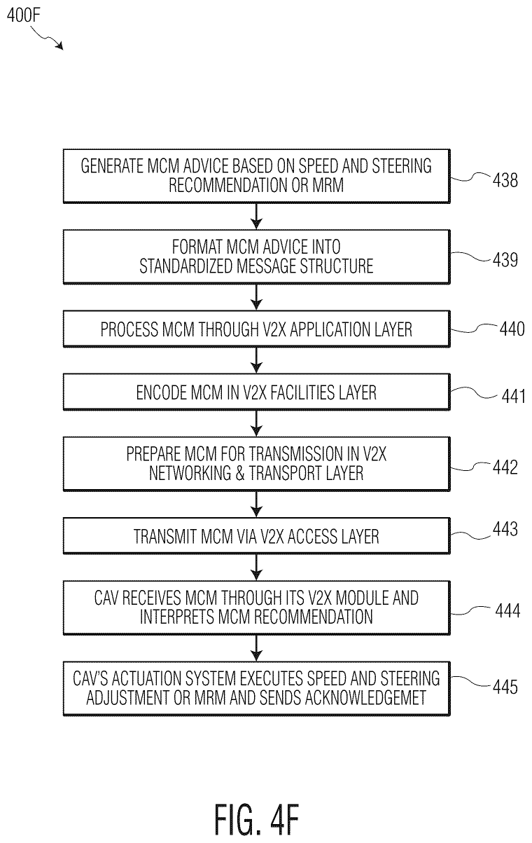

The flowcharts illustrated in FIGS. 4A-4F provide a detailed representation of the functionality and operational processes of the system 300 shown in FIG. 3. These flowcharts may depict various aspects of the system's operation, including data collection from road-side sensors, sensor fusion, feature extraction, driver intention prediction, DRL decision-making, safety checks, trajectory generation, and V2X communication. By breaking down the system into step-by-step processes, the flowcharts in FIGS. 4A-4F may offer a comprehensive view of how the different components of system 300 interact and function together to control CAVs using road infrastructure.

Referring first to FIG. 4A, a flowchart illustrates a process 400A for controlling an CAV using road infrastructure. The process 400A in FIG. 4A may include step 401 (collecting sensor data), step 402 (preprocessing and fusion), step 403 (feature extraction), step 404 (DIM prediction), step 405 (DRL agent decision-making), step 406 (features correction), step 407 (safe controller verification), step 408 (reference trajectory generation), step 409 (speed and/or steering recommendation calculations), step 410 (safety check), and step 411 (V2X communication to transmit recommendations).

The process 400A may begin with step 401, where infrastructure-mounted sensors, such as sensors 302a, 302b, 302c, up to 302n of the sensors module 302 (as shown in FIG. 3), collect data about the roadway and the vehicles on it. This data may include, but is not limited to, the positions, speeds, and directions of vehicles, as well as road conditions and traffic signals.

In aspects, the infrastructure-mounted sensors may include a variety of sensor types to provide comprehensive coverage of the roadway environment. These sensors may include cameras for visual data, LiDAR for precise distance measurements, radar for detecting moving objects, and infrared sensors for improved visibility in low-light conditions. The sensors may be strategically placed along the roadway to increase (e.g., maximize) coverage and decrease (e.g., minimize) blind spots, potentially including overhead gantries, roadside poles, and even embedded in the road surface itself.

In step 402, the collected data undergoes preprocessing and fusion. This may involve applying sensor-specific data processing methods, such as those implemented in data processing modules 304a, 304b, 304c, up to 304n (as shown in FIG. 3), to the raw sensor data. The preprocessed data from each sensor may be then fused together to create a unified representation of the roadway and the vehicles on it. This fusion may be performed by a fusion module 306 (as shown in FIG. 3).

The preprocessing and fusion step may involve various techniques to enhance the quality and reliability of the sensor data. For example, noise reduction algorithms may be applied to filter out irrelevant information, while data alignment techniques may be used to synchronize information from different sensors. The fusion process may employ methods such as Kalman filtering or particle filtering to combine data from multiple sensors, potentially improving the accuracy and robustness of the overall perception system. The fusion module 306 may process and combine data from multiple sensors to provide classified objects with their high-level descriptions. This fused data may include information such as the position and speed of detected objects. The features extraction module may then utilize this pre-processed information to identify and quantify relevant features for subsequent analysis. By leveraging the outputs of the fusion module, the feature extraction process may focus on deriving higher-level characteristics and relationships between the detected objects, potentially improving the efficiency and accuracy of the overall system.

In step 403, features may be extracted from the fused sensor data. This feature extraction may be performed by a features extraction module 310 (as shown in FIG. 3) and may involve identifying and quantifying relevant characteristics of the roadway and the vehicles, such as the distances between vehicles, the relative speeds of vehicles, and the positions of vehicles relative to lane markings.

The feature extraction process may utilize advanced techniques to derive higher-level characteristics from the fused sensor data provided by the fusion module 306. In aspects, these advanced features may include vehicle acceleration patterns, lane-changing behavior, driver attentiveness (for vehicles with visible drivers), inter-vehicle dynamics, traffic flow patterns, environmental adaptation, and predictive features. By analyzing these complex behaviors and relationships, the system may develop a more comprehensive understanding of the traffic situation. This enhanced feature set may provide beneficial inputs for subsequent modules such as DIM and DRL module, potentially improving their ability to anticipate and respond to complex traffic scenarios. The extraction of these advanced features may enable more accurate predictions and more effective decision-making for CAV control, particularly in dynamic and challenging traffic environments.

In step 404, a DIM 314 (as shown in FIG. 3) may be used to predict the behavior of human drivers on the roadway based on the extracted features. The DIM 314 may be a machine learning model trained to predict human driver behavior, such as whether a driver on the highway may be likely to yield or not during a merging scenario.

The DIM may incorporate various machine learning techniques to predict driver behavior. For example, it may use transformers, recurrent neural networks (RNNs), or long short-term memory (LSTM) networks to capture the temporal aspects of driver behavior. The model may be trained on large datasets of real-world driving scenarios, potentially including both normal driving conditions and edge cases. The DIM may also consider factors such as time of day, weather conditions, and even regional driving styles to improve its prediction accuracy.

In step 405, a DRL agent 320 (as shown in FIG. 3) generates control actions for the CAV based on the current traffic situation and the output from the DIM 314. The DRL agent 320 may be a machine learning model trained to make sophisticated and adaptive decisions for the CAV, such as determining appropriate speed recommendations for merging.

The DRL agent may employ advanced reinforcement learning algorithms such as Proximal Policy Optimization (PPO) or Soft Actor-Critic (SAC) to learn optimal control strategies. The agent may be trained in a simulated environment that closely mimics real-world traffic scenarios, allowing it to learn from a wide range of situations without the risks associated with real-world training. The DRL agent may also use a hierarchical structure, with high-level decision-making for overall strategy and low-level control for moment-to-moment actions.

It is noted that the DRL agent may consider multiple objectives when generating control actions for the CAV. These objectives may be defined in the reward function of the DRL. In aspects, these objectives may include minimizing travel time, maximizing energy efficiency, ensuring passenger comfort, maintaining safe distances from other vehicles, and optimizing overall traffic flow. The DRL module may balance these factors alongside safety considerations and goal achievement. Additionally, the module may take into account upcoming road geometry, traffic light timing, and the predicted behavior of surrounding vehicles. By incorporating these diverse factors, the DRL module may generate proactive control recommendations that anticipate future traffic conditions, potentially leading to more efficient and comfortable CAV operation while maintaining safety and contributing to improved traffic flow.

In step 406, a features correction module 318 (as shown in FIG. 3) may be activated if the state of the CAV deviates from the desired reference trajectory. The features correction module 318 adjusts the input features for the DIM 314 and DRL 320 models to compensate for the deviation.

The features correction module may use adaptive filtering techniques to adjust the input features based on the observed deviations. This may involve techniques such as Extended Kalman Filtering (EKF) or Unscented Kalman Filtering (UKF) to estimate and correct for errors in the feature extraction process. The module may also employ online learning techniques to continuously improve its correction capabilities based on observed discrepancies between predicted and actual vehicle behavior.

In step 407, a safe controller 322 (as shown in FIG. 3) verifies the control actions provided by the DRL agent 320 against predefined safety rules. If the control actions are not safe, the safe controller 322 may replace them with safe alternatives.

The safe controller may implement a multi-layered approach to ensure the safety of the generated control actions. This may include a rule-based layer for hard constraints (e.g., not exceeding speed limits), a model predictive control layer to anticipate and avoid potential conflicts, and a reactive layer for immediate collision avoidance. The safe controller may also use formal verification methods to provide mathematical guarantees of safety for decision-making processes.

In step 408, a reference trajectory generation module 324 (as shown in FIG. 3) generates a reference trajectory for the CAV based on the control actions provided by the DRL agent 320 and the safe controller 322. The reference trajectory represents the planned path of the CAV on the roadway.

The reference trajectory generation module may use optimization techniques such as Model Predictive Control (MPC) or Rapidly-exploring Random Trees (RRT) to generate smooth and efficient trajectories. The generated trajectories may also include contingency plans for potential unexpected events, allowing for quick adaptation to changing traffic conditions.

In step 409, a speed recommendation calculator 330 and steering recommendation calculator 322 (as shown in FIG. 3) calculates a recommended speed and/or steering for the CAV based on its current state and the reference trajectory. The speed and/or steering recommendation may be part of the instructions that will be transmitted to the CAV. The speed and/or steering recommendation calculators may use advanced algorithms to determine optimal speeds and steering. In step 410, a speed recommendation safety check module 334 and steering recommendation safety check module 336 (as shown in FIG. 3) checks whether the recommended speed and/or steering allows the CAV to track the reference trajectory. If the CAV cannot track the reference trajectory at the recommended speed and/or steering, the speed recommendation safety check module 334 or the steering recommendation safety check module 336 may generate an MRM, such as instructing the CAV to decelerate and pull over to a safe zone.

The speed recommendation safety check module and the steering recommendation safety check module may employ probabilistic risk assessment techniques to evaluate the safety of the recommended speed and/or steering. This may involve Monte Carlo simulations to consider various possible scenarios and their outcomes. The module may also use real-time physics-based vehicle dynamics models to accurately predict the vehicle's behavior at the recommended speed and/or steering, taking into account factors such as road surface conditions, tire grip, and vehicle load.

In step 411, a V2X module 342 (as shown in FIG. 3) transmits the instructions, including the speed recommendation or MRM, to the CAV. The V2X module 342 facilitates vehicle-to-everything communication, allowing the CAV to receive and execute the instructions.

The V2X module may implement advanced communication protocols to ensure reliable and secure transmission of instructions. This may include using techniques such as message authentication and encryption to protect against potential cyber-attacks. The module may also employ adaptive transmission strategies that adjust based on network conditions, prioritizing safety information in cases of limited bandwidth. Additionally, the V2X module may facilitate two-way communication, allowing the CAV to send status updates and sensor data back to the infrastructure, further enhancing the overall system's situational awareness and decision-making capabilities.

In aspects, the process 400A may include additional or different steps. For example, the process 400A may include steps for handling different traffic scenarios, such as intersections or roundabouts. The process 400A may also include steps for handling different types of vehicles, such as trucks or motorcycles. The process 400A may further include steps for handling different road conditions, such as wet or icy roads.

In the case of a CAV attempting to merge onto a main lane of a highway with other vehicles, the process illustrated in FIG. 4A may be particularly relevant. The system may begin by collecting sensor data (step 401) from infrastructure-mounted sensors along the highway, including the merge lane and main lanes. This data may include the positions, speeds, and trajectories of vehicles in the vicinity, as well as information about available gaps in the main lane traffic. The collected data undergoes preprocessing and fusion (step 402) to create a comprehensive representation of the current traffic situation, which may be then used for feature extraction (step 403) to identify characteristics such as the size of available gaps, speeds of vehicles in the main lane, and the position and speed of the merging CAV.

The DIM then predicts the behavior of human drivers in the main lane (step 404), assessing their likelihood of yielding or adjusting their speed to accommodate the merging CAV. Based on this prediction and the extracted features, the DRL agent generates control actions for the CAV (step 405), such as adjusting its speed and/or steering to align with an appropriate gap in traffic. These actions undergo safety verification (step 407) and may be used to generate a reference trajectory for the merge maneuver (step 408). The system calculates recommended speeds and steering for the CAV (step 409), performs a safety check (step 410), and transmits the instructions to the CAV via the V2X module (step 411), guiding it safely and efficiently through the merging process.

Referring to FIG. 4B, a flowchart illustrates a process 400B for collecting and processing sensor data for CAV control. The process 400B in FIG. 4B may include step 412 (collecting raw data from sensors), step 413 (preprocessing raw data), step 414 (applying sensor-specific object detection algorithms), step 415 (extracting relevant features), step 416 (fusing detected objects and features), step 417 (creating a unified environmental model), step 418 (updating LDM), and step 419 (outputting processed and fused data for AI modules).

The process 400B may begin with step 412, where raw data may be collected from infrastructure-mounted sensors, such as sensors 302a, 302b, 302c, up to 302n of the sensors module 302 (as shown in FIG. 3). The raw data may include images captured by cameras, providing visual information about the road environment and vehicles. Additionally, LiDAR sensors may generate 3D point clouds, offering detailed spatial information about the surroundings. Other sensor types may contribute different forms of raw data, each providing unique perspectives on the traffic situation and road conditions.

In aspects, the infrastructure-mounted sensors may employ various sensing technologies to capture a wide range of data. For example, radar sensors may be used to detect vehicle speeds and distances, while thermal cameras may be utilized for enhanced visibility in low-light conditions or adverse weather. Additionally, the system may incorporate acoustic sensors to detect emergency vehicles or other sound-based information, and magnetometers to detect the presence of vehicles at specific locations such as intersections or parking spaces.

In step 413, the collected data undergoes preprocessing. This may involve applying sensor-specific data processing methods, such as those implemented in data processing modules 304a, 304b, 304c, up to 304n (as shown in FIG. 3), to the raw sensor data. The preprocessing may include, for example, noise reduction, normalization, or other suitable preprocessing techniques.

The preprocessing step may also involve data augmentation techniques to enhance the quality and quantity of the collected data. This may include methods such as image rotation, flipping, or adding synthetic noise to camera data to improve the robustness of subsequent object detection algorithms. For LiDAR data, preprocessing may involve point cloud down-sampling or up-sampling to standardize data density, while for radar data, Doppler processing may be applied to extract velocity information.

Following preprocessing, the process 400B moves to step 414, where sensor-specific object detection algorithms may be applied to the preprocessed data. These algorithms may include, for example, YOLO for camera data, PointPillars for LiDAR data, or other suitable object detection algorithms. The object detection algorithms identify and classify objects in the sensor data, such as vehicles, pedestrians, or other objects of interest.

In cases, the system may employ ensemble methods, combining multiple object detection algorithms to improve accuracy and robustness. For instance, the results from YOLO and SSD (Single Shot Detector) may be fused for camera data, while PointPillars and VoxelNet may be combined for LiDAR data. The system may also utilize temporal information, tracking objects across multiple frames to improve detection stability and predict object trajectories.

In step 415, the detected objects and features from multiple sensors may be preprocessed and fused together. This fusion may be performed by a fusion module 306 (as shown in FIG. 3). The fusion process combines the data from different sensors to create a unified representation of the roadway and the vehicles on it. This fused data provides a comprehensive view of the roadway, overcoming the limitations of individual sensors and enhancing the accuracy and reliability of the data. The fusion process may employ advanced techniques such as probabilistic fusion methods to handle uncertainties in sensor measurements. For instance, Kalman filtering or particle filtering may be used to combine position and velocity estimates from different sensors, taking into account the varying accuracies and update rates of each sensor. The fusion module may also implement conflict resolution strategies to handle discrepancies between different sensors, ensuring a consistent and accurate representation of the environment.

In step 416, relevant features may be extracted from the detected objects in the fused data. This feature extraction may be performed by a features extraction module 310 (as shown in FIG. 3) and may involve identifying and quantifying relevant characteristics of the detected objects, such as the distances between vehicles, the relative speeds of vehicles, and the positions of vehicles relative to lane markings.

The feature extraction process may also incorporate higher-level features that provide context about the traffic situation. For example, the system may extract features related to traffic flow patterns, such as speed, position and relative distances between vehicles. It may also identify, and extract features related to driver behavior, such as sudden lane changes or aggressive acceleration/deceleration patterns. These higher-level features may provide beneficial input for subsequent decision-making processes.

In step 417, a unified environmental model may be created based on the features extracted from the fused data. This model represents the current state of the roadway and the vehicles on it, providing a comprehensive and accurate representation of the driving environment.

The unified environmental model may incorporate semantic information to enhance its representation of the driving environment. For example, it may include lane-level details such as lane types (e.g., regular lanes, HOV lanes, emergency lanes) and lane connectivity information. The model may also incorporate dynamic elements such as temporary road works, variable speed limits, or traffic signal phases. This rich, semantic representation of the environment may enable more sophisticated decision-making by the CAV control system.

In step 418, a LDM may be updated with the fused data. The LDM provides a dynamic representation of the roadway and the vehicles on it, updating in real-time as new sensor data may be collected and processed. The LDM can provide beneficial context for the AI models, helping them to understand the current traffic situation and make more accurate predictions and decisions.

The LDM may be designed with a multi-layered structure to efficiently represent different types of information. For instance, it may include a static layer for permanent road features, a semi-dynamic layer for temporary changes like road works, and a highly dynamic layer for moving objects. The LDM may also implement efficient data structures and update mechanisms to handle high-frequency updates from the features extraction module while maintaining low latency access for the AI modules.

In step 419, the processed and fused data may be output for further analysis by AI modules. This data may include the extracted features, the unified environmental model, and the updated LDM. The AI modules can use this data to generate control actions for the CAV, as will be described in more detail below.

The output data may be formatted and structured to facilitate efficient processing by various AI modules. For example, the system may employ standardized data formats or protocols to ensure interoperability between different modules. It may also implement data streaming mechanisms to provide real-time updates to the AI modules, enabling them to react quickly to changing traffic conditions. Additionally, the system may include metadata with the output data, such as timestamps or confidence scores, to assist the AI modules in assessing the reliability and relevance of the information.

In aspects, the process 400B may include additional or different steps. For example, the process 400B may include steps for handling different traffic scenarios, such as intersections or roundabouts. The process 400B may also include steps for handling different types of vehicles, such as trucks or motorcycles. The process 400B may further include steps for handling different road conditions, such as wet or icy roads.

In the context of a CAV attempting to merge onto a main lane of a highway, the process illustrated in FIG. 4B plays a role in providing a comprehensive understanding of the traffic situation. The process may begin with the collection of raw data from infrastructure-mounted sensors (step 412), which may be used in subsequent steps by the fusion and feature extraction modules to determine information about the positions, speeds, and trajectories of vehicles in the vicinity, as well as details about available gaps in the main lane traffic. This data undergoes preprocessing (step 413) and sensor-specific object detection (step 414) to identify and classify vehicles, pedestrians, and other relevant objects in the merging scenario.

The subsequent steps of fusion of detected objects and features (step 415), and feature extraction (step 416), and creation of a unified environmental model (step 417) may be particularly important for the merging use case. These steps allow the system to identify characteristics such as the size of available gaps, speeds of vehicles in the main lane, and the position and speed of the merging CAV. The updated LDM (step 418) provides a real-time representation of the highway environment, including both the merge lane and main lanes. This processed and fused data (step 419) serves as input for the AI modules, enabling them to generate accurate predictions of driver behavior and optimal control actions for the merging CAV, facilitating a safe and efficient merge maneuver.

Referring to FIG. 4C, a flowchart illustrates a process 400C for generating and verifying recommended actions for a CAV using road infrastructure. The process 400C in FIG. 4C may include step 420 (feature extraction), step 421 (DIM prediction), step 422 (combining DIM output and extracted features for DRL input), step 423 (DRL generating recommended action), and step 424 (safe controller verifying DRL action).

The process 400C may begin with step 420, where features may be extracted from the detected vehicles. This feature extraction may be performed by a features extraction module 310 (as shown in FIG. 3) and may involve identifying and quantifying relevant characteristics of the detected vehicles, such as the distances between vehicles, the relative speeds of vehicles, and the positions of vehicles relative to lane markings.

In aspects, the feature extraction process may utilize advanced computer vision and machine learning techniques to extract a wide range of features from the detected vehicles. These features may include basic positional and kinematic information, higher-level characteristics such as vehicle type classification, estimated acceleration patterns, and predicted trajectories. The system may also extract contextual features from the surrounding environment, such as road curvature, traffic density, and weather conditions, which can provide beneficial additional information for subsequent decision-making processes.

In step 421, these extracted features may be input to a DIM 314 (as shown in FIG. 3) to predict human driver intentions. The DIM 314 may be a machine learning model that provides an estimation of human driver behaviors, such as whether a driver on the highway is likely to yield or not during a merging scenario. The DIM 314 may be trained using supervised or unsupervised learning methods.

The DIM 314 may employ various advanced machine learning techniques to improve its prediction accuracy. For instance, it may use ensemble methods that combine multiple models, such as decision trees, neural networks, and support vector machines, to generate more robust predictions. The DIM 314 may also incorporate temporal information by using transformers, RNNs, or LSTM networks to capture the sequential nature of driver behavior. Additionally, the model may be continuously updated using online learning techniques to adapt to changing traffic patterns and driver behaviors over time.

Following the prediction of human driver intentions, the process 400C moves to step 422, where the DIM output and the extracted features may be combined and input to a DRL module 320 (as shown in FIG. 3). The DRL module 320 generates control actions for the CAV based on the current traffic situation and the output from the DIM 314. The DRL module 320 may be responsible for making sophisticated and adaptive decisions for the CAV, such as determining appropriate speed recommendations for merging.

The DRL module 320 may utilize advanced reinforcement learning algorithms such as Proximal Policy Optimization (PPO) or Soft Actor-Critic (SAC) to learn optimal control strategies. These algorithms may allow the DRL module to efficiently explore the action space and learn from complex, high-dimensional state representations. The module may also incorporate multi-agent reinforcement learning techniques to better handle scenarios involving multiple CAVs or to anticipate the actions of HDVs. Furthermore, the DRL module may use hierarchical reinforcement learning approaches to decompose complex driving tasks into more manageable sub-tasks, potentially improving learning efficiency and generalization to new scenarios.

In step 423, the DRL module 320 (as shown in FIG. 3) generates recommended actions for the CAV based on the combined input from the DIM output and extracted features. The DRL module 320 may utilize advanced reinforcement learning algorithms to determine appropriate control actions, such as acceleration, deceleration, or steering recommendations, for the CAV in various traffic scenarios.

In step 424, the safe controller performs a verification process on the control actions generated by the DRL module. This step may involve a comprehensive evaluation of the proposed actions against a set of predefined safety rules and constraints. The safe controller may analyze various aspects of the recommended actions, such as their potential impact on the vehicle's trajectory, speed, and proximity to other vehicles or obstacles. It may also consider factors like current road conditions, weather, and traffic regulations to ensure that the actions comply with relevant safety standards.

If the safe controller module 322 (as shown in FIG. 3) determines that the DRL-generated actions are within acceptable safety parameters, it may approve them for execution by the CAV. However, if any safety concerns are identified, the safe controller may modify the actions or replace them with safer alternatives. This process may involve adjusting speed recommendations, altering steering angles, or even initiating emergency maneuvers. By implementing this rigorous safety check, the system aims to maintain a high level of safety and reliability in CAV operations, particularly in complex traffic scenarios such as highway merging.

In aspects, the process 400C may include additional or different steps. For example, the process 400C may include steps for handling different traffic scenarios, such as intersections or roundabouts. The process 400C may also include steps for handling different types of vehicles, such as trucks or motorcycles. The process 400C may further include steps for handling different road conditions, such as wet or icy roads.

In the context of a CAV attempting to merge onto a main lane of a highway, the process illustrated in FIG. 4C plays a role in generating and verifying recommended actions for the CAV. The process may begin with feature extraction (step 420), where relevant characteristics of the detected vehicles may be identified and quantified. These features may include the size of available gaps in the main lane traffic, speeds of vehicles in the main lane, and the position and speed of the merging CAV. The extracted features may be then input into a DIM (step 421) to predict the behavior of human drivers on the highway, such as their likelihood to yield to the merging CAV.

The process then combines the DIM output with the extracted features (step 422) to provide input for a DRL module. The DRL module generates recommended actions for the CAV (step 423), such as adjusting its speed or steering to safely merge into an identified gap. A safe controller verifies these recommended actions (step 424) against predefined safety rules, ensuring that the proposed maneuver complies with traffic regulations and does not put the CAV or other vehicles at risk. This process enables the system to generate sophisticated, adaptive, and safe control actions for the CAV, facilitating smooth and efficient merging onto the highway while considering the predicted behavior of human drivers and maintaining overall traffic safety.

Referring to FIG. 4D, a flowchart illustrates a process 400D for adjusting input features for machine learning models in a vehicle control system. The process 400D may include step 425 (receiving the CAV's actual state and reference trajectory), step 426 (calculating the deviation between the CAV's actual state and the reference trajectory), and step 427 (adjusting the input features for the DIM and DRL models if the features correction module is activated).

The process 400D may begin with step 425, where the system receives the actual state of the CAV and the reference trajectory. The actual state of the CAV may include, but is not limited to, the CAV's current position, speed, and direction. The reference trajectory represents the planned path of the CAV on the roadway, which may be generated based on the control actions provided by the DRL module 320 and the safe controller 322 (as shown in FIG. 3).

In aspects, the system may receive additional information about the CAV's state, such as its acceleration, yaw rate, and steering angle. The system may also receive data from the CAV's onboard sensors, including information about nearby vehicles, road conditions, and traffic signs. This comprehensive state information may allow for more accurate comparisons between the actual state and the reference trajectory. The reference trajectory may be represented as a series of waypoints or a continuous function, and may include positional information, expected speeds and accelerations at each point along the path.

In step 426, the process calculates the deviation between the CAV's actual state and the reference trajectory. This deviation represents the difference between the CAV's current path and its planned path. The deviation may be calculated using various methods, such as subtracting the actual state from the reference trajectory or using a more complex calculation that takes into account the direction and speed of the CAV.

The deviation calculation may involve multiple dimensions, including lateral deviation (distance from the planned path), longitudinal deviation (distance ahead or behind the planned position), and temporal deviation (time difference between actual and planned arrival at a given point). The system may use techniques such as Euclidean distance calculation for spatial deviations and time-to-arrival differences for temporal deviations. In cases, the deviation may be weighted based on the importance of different factors, such as prioritizing lateral deviation over longitudinal deviation in scenarios.

If the features correction module 318 (as shown in FIG. 3) is activated, the process moves to step 427, where the system adjusts the input features for the DIM 314 and DRL 320 models based on the deviation. The features correction module 318 compensates for errors that may be incorporated into the inputs of the AI models when the state of the CAV deviates from the desired reference trajectory. This deviation may be due to various factors, such as uncertainties and non-linearities of vehicle dynamic models, control lags, and reinforcement learning transferability bias. The features correction module 318 improves the robustness of the AI models' outputs by adjusting the extracted features for the DIM 314 and DRL 320 modules based on the deviation. This adjustment may include adding corrective terms to the extracted features.

The features correction module may employ various techniques to adjust the input features. For example, it may use Kalman filtering to estimate the true state of the CAV and correct the input features accordingly. The module may also use adaptive algorithms that adjust the magnitude of corrections based on the size and persistence of deviations. In implementations, the features correction module may maintain a history of deviations and corrections, allowing it to identify patterns and anticipate future deviations. The corrected features may then be used to update the internal state representations of the DIM and DRL models, potentially improving their prediction and decision-making capabilities in subsequent iterations.

In aspects, the features correction module 318 may use various methods to adjust the input features. For example, the features correction module 318 may adjust the input features by adding or subtracting a correction factor based on the deviation. The correction factor may be a constant value, a proportional value based on the deviation, or a value determined by a more complex function of the deviation. The features correction module 318 may also adjust the input features by scaling them based on the deviation, such as multiplying the input features by a scaling factor determined by the deviation.

In cases, the features correction module 318 may adjust different types of input features in different ways. For example, the features correction module 318 may adjust positional features (such as the distance between vehicles) by adding or subtracting a correction factor, while adjusting velocity features (such as the relative speed of vehicles) by scaling them. The specific methods used to adjust the input features may depend on the characteristics of the input features and the nature of the deviation.

In aspects, the features correction module 318 may adjust the input features dynamically based on the current traffic situation and the performance of the CAV. For example, the features correction module 318 may adjust the input features more aggressively when the traffic is heavy or when the CAV is deviating significantly from the reference trajectory. Conversely, the features correction module 318 may adjust the input features more conservatively when the traffic is light or when the CAV is closely following the reference trajectory. This dynamic adjustment of the input features allows the system to adapt to changing conditions and optimize the performance of the CAV.

In the context of a CAV attempting to merge onto a main lane of a highway, the process illustrated in FIG. 4D plays a role in maintaining accurate and up-to-date input features for the DIM and DRL modules. As the CAV navigates the merging scenario, its actual state may deviate from the planned reference trajectory due to various factors such as unexpected behavior of other vehicles, changes in road conditions, or inaccuracies in the vehicle's control systems. The process may begin by receiving the CAV's actual state and reference trajectory (step 425), which may include information such as the CAV's current position relative to the merge point, its speed, and the positions and speeds of vehicles in the main lane.

The system then calculates the deviation between the CAV's actual state and the reference trajectory (step 426), which may be particularly useful in a merging scenario where precise positioning and timing may be beneficial. If the features correction module is activated, the system adjusts the input features for the DIM and DRL models based on this deviation (step 427). This adjustment may involve updating features such as the estimated time to the merge point, the size of available gaps in the main lane traffic, or the relative speeds of nearby vehicles. By continuously refining these input features, the system can provide more accurate predictions of other drivers' intentions and generate more appropriate control actions for the CAV, potentially improving the safety and efficiency of the merging maneuver, and preventing unstable behaviors.

Referring to FIG. 4E, a flowchart illustrates a process 400E for generating and verifying trajectory recommendations for a CAV. The process 400E may include step 428 (reference trajectory generation), step 429 (trajectory extrapolation), step 430 (speed and/or steering recommendation calculation), step 431 (trajectory tracking check), decision 432 (deviation threshold check), step 433 (output final recommendation), step 434 (MRM generation), step 435 (features correction module deactivation), step 436 (reference trajectory reset), and step 437 (output MRM).

Step 428 involves the generation of a reference trajectory for the CAV. This reference trajectory may be based on the outputs from the DRL module and the safe controller. The reference trajectory represents the ideal path that the CAV should follow, taking into account factors such as the current traffic situation, road conditions, and the CAV's destination.

The reference trajectory generation process may involve complex algorithms that consider multiple variables, including the predicted behavior of other vehicles, traffic rules, and the CAV's capabilities. This step may be beneficial as it provides a baseline for the CAV's intended movement, against which actual performance can be compared.

Step 429 focuses on trajectory extrapolation. In this step, the system may extend the planned trajectory of the CAV beyond the immediate future. This extrapolation may help compensate for uncertainties in vehicle dynamics, potential delays in control execution, and other factors that may affect the CAV's ability to follow the reference trajectory precisely.

The extrapolation process may use advanced prediction models that take into account the CAV's current state, its planned actions, and potential external influences. This step may be particularly useful in dynamic environments where conditions can change rapidly, allowing the system to anticipate and prepare for potential future scenarios.

Step 430 involves the calculation of speed and/or steering recommendations for the CAV. These recommendations may be based on the CAV's current state and its position relative to the reference trajectory. The system may use sophisticated algorithms to determine the optimal speed and/or steering inputs that will allow the CAV to follow the reference trajectory as closely as possible. The calculation process may consider various factors. The recommendations generated in this step serve as direct inputs to the CAV's control systems, guiding its moment-to-moment actions as it navigates the roadway.

Step 431 may be a trajectory tracking check. In this step, the system may evaluate whether the recommended speed and/or steering inputs will allow the CAV to effectively follow the reference trajectory. This check may involve simulating the CAV's movement using the recommended inputs and parameters such as its maximum acceleration, maximum steering, and maximum braking, and comparing the resulting path to the reference trajectory.

The trajectory tracking check may use advanced modeling techniques to predict the CAV's behavior under the recommended inputs. This step serves as a validation process, ensuring that the generated recommendations are likely to produce the desired outcome before they are actually applied.

Decision 432 involves checking if the deviation between the CAV's projected path and the reference trajectory is below a threshold. This decision point may act as a safety check, ensuring that the CAV's planned movement doesn't stray too far from the intended path.

If the deviation is below the threshold, the process may proceed with applying the recommendations. However, if the deviation exceeds the threshold, it may trigger alternative actions to ensure the CAV's safe operation. This decision point may play a role in maintaining the overall safety and efficiency of the autonomous driving system.

Step 433 involves outputting the final speed and/or steering recommendation for the CAV. This step may occur if the deviation checked in decision 432 is below the threshold. The final recommendation may be the result of the previous calculations, checks, and validations.

The output from this step may be in a format that can be directly interpreted and executed by the CAV's control systems. It may include not just the immediate actions to be taken, but also a sequence of planned actions over a short time horizon, allowing for smooth and anticipatory control of the vehicle.

Step 434 involves the generation of an MRM. This step may be triggered if the deviation checked in decision 432 is above the threshold. An MRM may be a predefined set of actions designed to bring the CAV to a safe state with minimal risk to itself and other road users.

The MRM generation process may consider various factors such as the current traffic situation, road conditions, and the nature of the deviation that triggered it. The goal of the MRM may be to safely bring the CAV to a stop, move it to a designated safe zone, or execute another predefined safety protocol.

Step 435 involves the deactivation of the features correction module. This step may occur as part of the MRM execution process. Deactivating the features correction module may prevent it from introducing additional adjustments that may interfere with the execution of the MRM, or generating actions based on a reference trajectory that is deviated, above a threshold, from the CAV's projected path.

The deactivation process may involve setting system flags or switching to a different operational mode. This step may be beneficial in ensuring that the MRM can be executed without interference from other system components that might otherwise try to maintain normal operation.

Step 436 involves resetting the reference trajectory to the current CAV state. This step may also be part of the MRM execution process. By resetting the reference trajectory, the system acknowledges that the previous plan is no longer valid and establishes a new baseline from which to plan future actions.

The reset process may involve capturing the CAV's current state (position, speed, orientation, etc.) and using it as the starting point for any future trajectory planning. This step may be beneficial in allowing the system to recover from the situation that triggered the MRM and begin planning safe future actions.

Step 437 is where the system outputs the MRM for execution by the CAV. This output may include a series of specific instructions for the CAV to follow, such as reducing speed, changing lanes, or coming to a stop in a safe location.

The MRM output may be prioritized over other system outputs to ensure it may be executed immediately and without interference. This step may be beneficial in ensuring the safety of the CAV and other road users in situations where normal operation may be no longer possible or safe.

In aspects, the process 400E may include additional or different steps. For example, the process 400E may include steps for handling different traffic scenarios, such as intersections or roundabouts. The process 400E may also include steps for handling different types of vehicles, such as trucks or motorcycles. The process 400E may further include steps for handling different road conditions, such as wet or icy roads.

In the context of a CAV attempting to merge onto a main lane of a highway, the process illustrated in FIG. 4E plays a role in generating and verifying trajectory recommendations. The process may begin with the generation of a reference trajectory (step 428) based on outputs from the DRL module and safe controller, taking into account the current traffic situation, road conditions, and the CAV's destination. This may be followed by trajectory extrapolation (step 429) to compensate for uncertainties in vehicle dynamics and potential delays in control execution. The system then calculates speed and/or steering recommendations (step 430) based on the CAV's current state and its position relative to the reference trajectory. A trajectory tracking check (step 431) may be performed to evaluate whether the recommended inputs will allow the CAV to effectively follow the reference trajectory, followed by a deviation threshold check (decision 432) to ensure the CAV's planned movement doesn't stray too far from the intended path.

If the deviation is below the threshold, the final speed and/or steering recommendations may be output for the CAV (step 433). However, if the deviation exceeds the threshold, the system generates a MRM (step 434), which may involve safely bringing the CAV to a stop or moving it to a designated safe zone. In this case, the features correction module may be deactivated (step 435) to prevent interference with the MRM execution, and the reference trajectory may be reset to the current CAV state (step 436). The MRM may be output for execution by the CAV (step 437), prioritized over other system outputs to ensure immediate execution. This process ensures that the CAV can safely and efficiently merge onto the highway, adapting to changing traffic conditions and maintaining safety even in situations where normal operation may be no longer possible or safe.

Referring to FIG. 4F, a flowchart illustrates a process 400F for generating and transmitting MCMs to a CAV. The process 400F may include step 438 (MCM advice generation), step 439 (MCM formatting), step 440 (MCM processing through V2X application layer), step 441 (MCM encoding in V2X facilities layer), step 442 (MCM preparation in V2X networking and transport layer), step 443 (MCM transmission via V2X access layer), step 444 (CAV receiving and interpreting MCM), and step 445 (CAV executing speed and/or steering adjustment or MRM and sending acknowledgement).

The process 400F may begin with step 438, where an MCM advice may be generated based on speed and/or steering recommendations or an MRM. The MCM advice may include instructions comprising speed recommendations, steering recommendations, acceleration profiles, and anticipated merge points for the CAV. The MCM advice may be then formatted into a standardized message structure in step 439.

In step 440, the MCM may be processed through a V2X module 342 (as shown in FIG. 3) in the application layer 344. The V2X module 342 may include multiple layers, such as an application layer 344, a service layer 346, a network and transport layer 348, and an access layer 350. These layers facilitate the formatting, processing, and transmission of the MCM to the CAV.

The application layer 344 may handle the creation of an MCM. The service layer 346 may handle high-level functions such as message prioritization and security protocols. It may ensure that messages are given precedence and that communications are encrypted to protect against potential cyber threats. The network and transport layer 348 may manage the routing of messages and ensure reliable delivery, while the access layer 350 may handle the physical transmission of data.

In step 441, the MCM may be encoded in the V2X facilities layer. This encoding process may involve converting the MCM into a format that can be transmitted over the network and understood by the CAV.

The encoding process may use standardized protocols to ensure interoperability between different vehicle manufacturers and infrastructure systems. The facilities layer may also add metadata to the MCM, such as timestamps and location information, to provide context for the receiving vehicle. This layer may also handle message compression to optimize bandwidth usage.

In step 442, the MCM may be prepared for transmission in the V2X networking and transport layer. This preparation may involve packaging the MCM into a data packet, adding headers and footers, and performing error checking procedures.

The networking and transport layer may implement advanced routing algorithms to determine the most efficient path for the MCM to reach its destination. It may also handle packet fragmentation and reassembly for large messages and implement congestion control mechanisms to manage network traffic. This layer may also provide QoS features to ensure timely delivery of messages.

In step 443, the MCM may be transmitted via the V2X access layer. The V2X access layer may include various communication technologies, such as Wi-Fi, cellular networks, or dedicated short-range communications (DSRC), to transmit the MCM to the CAV.

The access layer may dynamically select the most appropriate communication technology based on factors such as signal strength, bandwidth availability, and latency requirements. It may also implement adaptive modulation and coding schemes to optimize transmission in varying channel conditions. The access layer may support multi-hop communication to extend the range of V2X messages in areas with limited infrastructure.

In step 444, the CAV receives the MCM through its V2X module. The V2X module of the CAV decodes the MCM and interprets the instructions contained within it. The CAV's V2X module may employ advanced signal processing techniques to extract the MCM from potentially noisy or interfered channels. It may perform integrity checks to ensure the received message is complete and uncorrupted. The module may also authenticate the source of the MCM to prevent spoofing attacks and ensure the reliability of the received instructions.

In step 444, the CAV's control system processes the MCM recommendation. This processing may involve calculating, based on the MCM recommendation, control signals that can be understood by the CAV's actuation system.

The control system may use sensor fusion techniques to integrate the MCM recommendations with data from the CAV's onboard sensors. It may employ predictive algorithms to anticipate the effects of implementing the recommendations and adjust them based on real-time conditions. The control system may also perform safety checks to ensure the recommendations do not conflict with the CAV's internal safety protocols.

In step 445, the CAV's actuation system executes the speed and/or steering adjustment or MRM based on the MCM recommendation. The CAV then sends an acknowledgment of MCM reception and execution back to the system.

The actuation system may use advanced control algorithms to smoothly implement the recommended actions, optimizing for passenger comfort and energy efficiency. It may continuously monitor the execution of the actions and make fine-tuned adjustments as needed. The acknowledgment sent back to the system may include detailed telemetry data about the CAV's response to the MCM, which can be used for system optimization and performance analysis.

In aspects, the process 400F may include additional or different steps. For example, the process 400F may include steps for handling different types of MCMs, such as MCMs for lane changes or intersection crossings. The process 400F may also include steps for handling different types of vehicles, such as trucks or motorcycles. The process 400F may further include steps for handling different communication technologies or protocols in the V2X module.

In the context of a CAV attempting to merge onto a main lane of a highway, the process illustrated in FIG. 4F plays a role in facilitating safe and efficient merging. The process may begin with the generation of MCM advice (step 438) based on the speed and/or steering recommendations calculated in the previous steps or a MRM. This MCM advice may include specific instructions for the merging CAV, such as recommended speeds, steering angles, acceleration profiles, and the anticipated merge point. The MCM may be then formatted (step 439), processed through the V2X application layer (step 440), encoded in the V2X facilities layer (step 441), prepared for transmission in the V2X networking and transport layer (step 442), and finally transmitted via the V2X access layer (step 443). These steps ensure that the merging instructions are properly formatted, secured, and efficiently transmitted to the CAV using the most appropriate communication technology for the current conditions.

Upon receiving the MCM (step 444), the CAV's V2X module decodes and interprets the instructions, authenticating the source to prevent potential security threats. The CAV's control system then processes the MCM recommendation (step 444), integrating it with data from its onboard sensors and performing safety checks to ensure the instructions do not conflict with its internal safety protocols. The CAV executes the speed and/or steering adjustments or MRM as instructed (step 445), using advanced control algorithms to implement the actions smoothly and efficiently. The CAV then sends an acknowledgment back to the system, potentially including detailed telemetry data about its response to the MCM. This process allows for real-time coordination between the infrastructure-based control system and the CAV, enabling adaptive and safe merging maneuvers that take into account current traffic conditions, the behavior of other vehicles, and the specific capabilities of the CAV.

It is noted that the system shown in FIG. 3 and the methods in FIGS. 4A-4F may include various modifications to enhance their functionality and adaptability to different scenarios. These modifications may allow the system to handle a wider range of traffic situations, vehicle types, and environmental conditions.

In aspects, the sensors module 302 may be expanded to include additional types of sensors. For example, thermal cameras may be added to improve detection capabilities in low-light conditions or adverse weather. Acoustic sensors may also be incorporated to detect emergency vehicles or other sound-based information. These additional sensors may provide more comprehensive environmental data, potentially improving the system's overall perception and decision-making capabilities.

The fusion module 306 may be modified to implement more advanced fusion algorithms. For instance, the system may incorporate probabilistic fusion methods to better handle uncertainties in sensor measurements. This modification may improve the accuracy of the fused data, leading to more reliable input for subsequent modules.

In cases, the DIM 314 and the DRL module 320 may be enhanced to handle a broader range of scenarios. The DIM may be trained on additional datasets that include various traffic situations, such as intersections, roundabouts, or complex multi-lane merges. This expansion may allow the DIM to provide more accurate predictions in diverse traffic environments. Similarly, the DRL module may be modified to generate control actions for different types of vehicles, such as trucks or motorcycles, each with their unique dynamics and constraints.

The safe controller 322 may be adapted to include additional safety rules and constraints. For example, it may incorporate specific rules for different weather conditions, such as reduced speed limits during rain or snow. The safe controller may also be modified to handle emergency situations, such as sudden obstacles or vehicle malfunctions, by implementing more sophisticated emergency maneuver algorithms.

In aspects, the reference trajectory generation module 324 may be enhanced to consider additional factors when generating trajectories. For instance, it may take into account road gradient, curvature, and surface conditions to generate more realistic and safe trajectories. The module may also be modified to generate multiple potential trajectories and select the optimal one based on various criteria such as safety, efficiency, and passenger comfort.

The V2X module 342 may be expanded to support additional communication protocols and technologies. This modification may allow the system to communicate with a wider range of vehicles and infrastructure elements, potentially improving its effectiveness in mixed traffic environments with varying levels of vehicle connectivity.

The methods illustrated in FIGS. 4A-4F may also be modified to include additional steps or decision points. For example, the process 400A may be expanded to include a step for real-time traffic flow optimization. This step may involve adjusting the behavior of multiple CAVs simultaneously to improve overall traffic efficiency. The process 400C may be modified to include a step for handling unexpected events, such as sudden lane closures or accidents, by rapidly re-planning trajectories and control actions.

These modifications may enhance the system's ability to handle complex real-world scenarios, improve its adaptability to different environments and vehicle types, and increase its effectiveness in improving road safety and traffic efficiency.

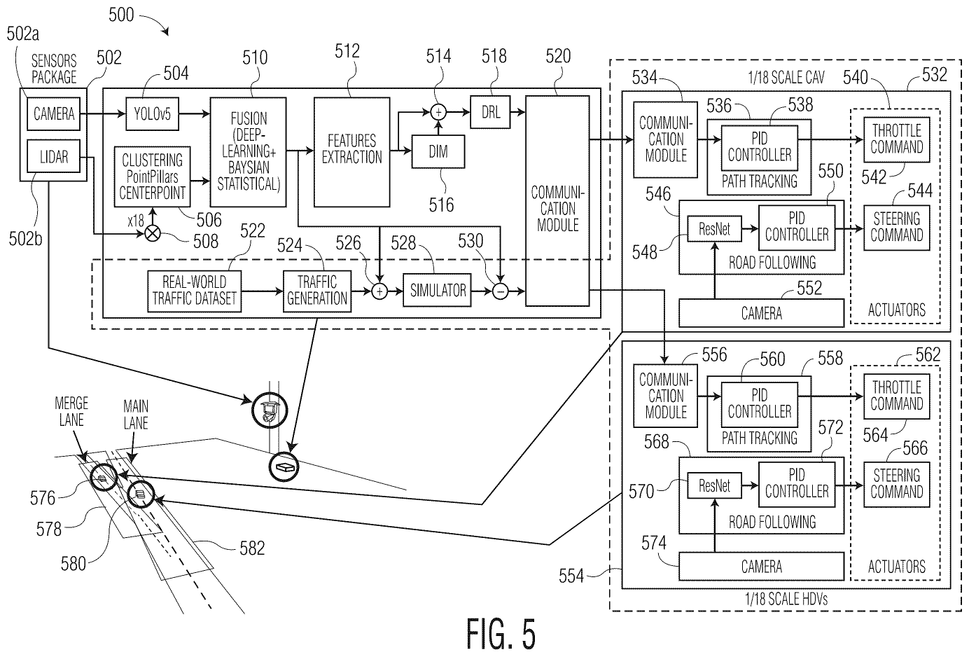

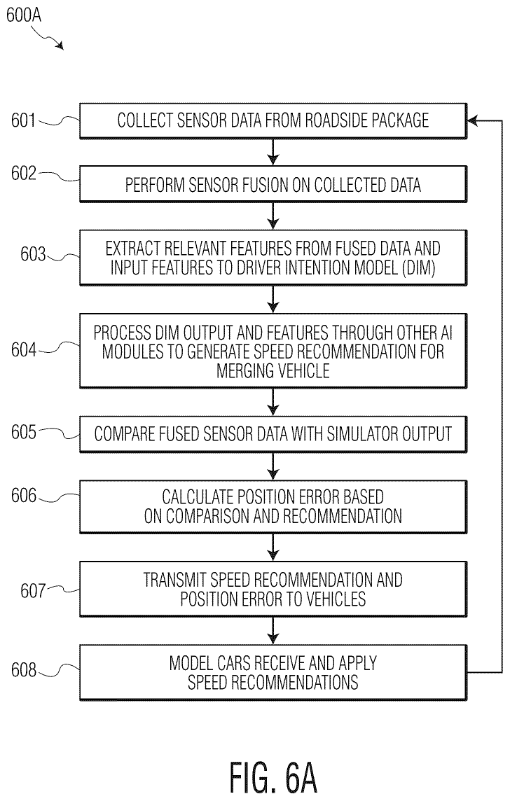

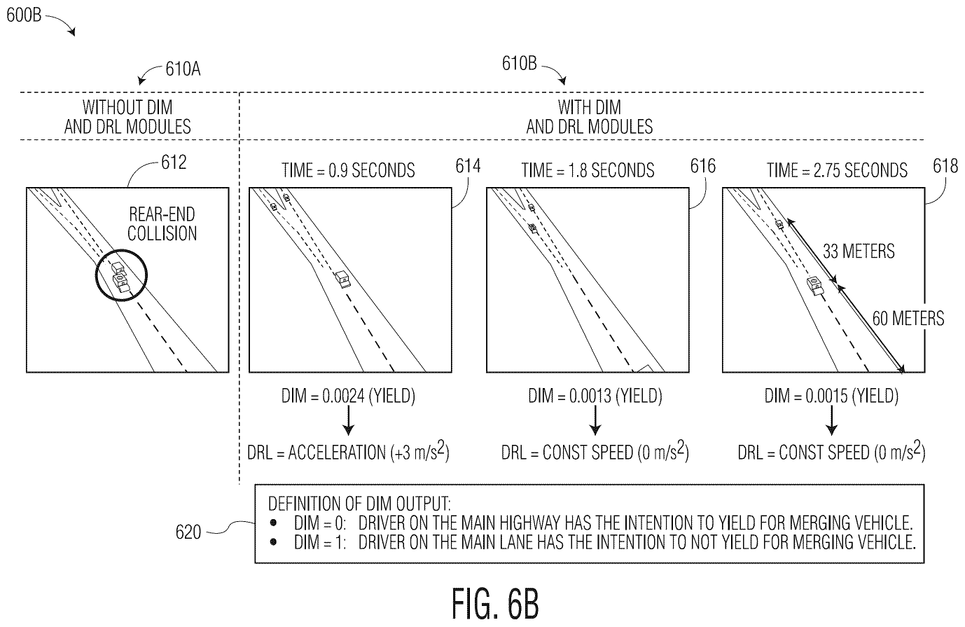

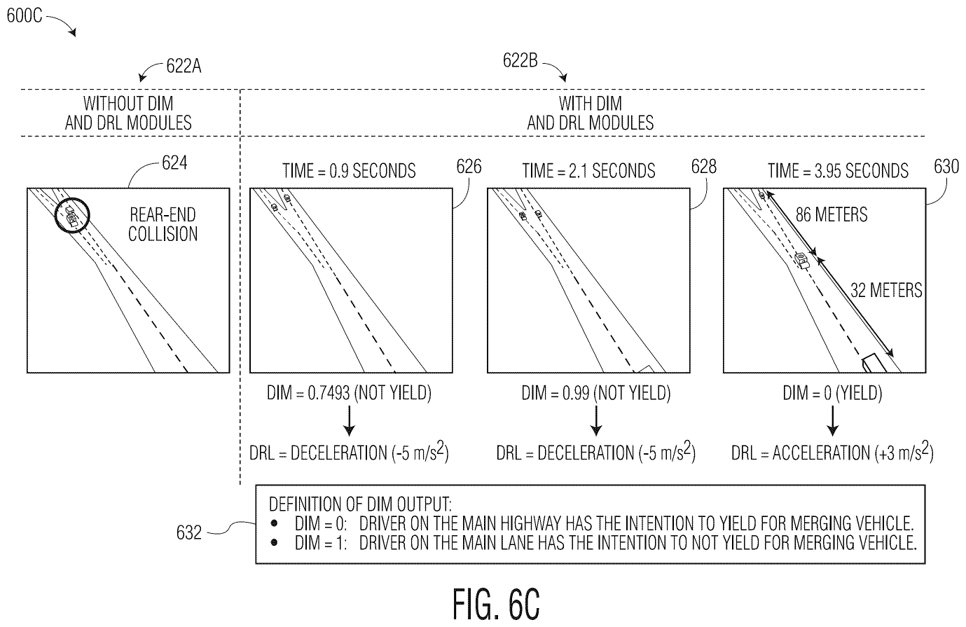

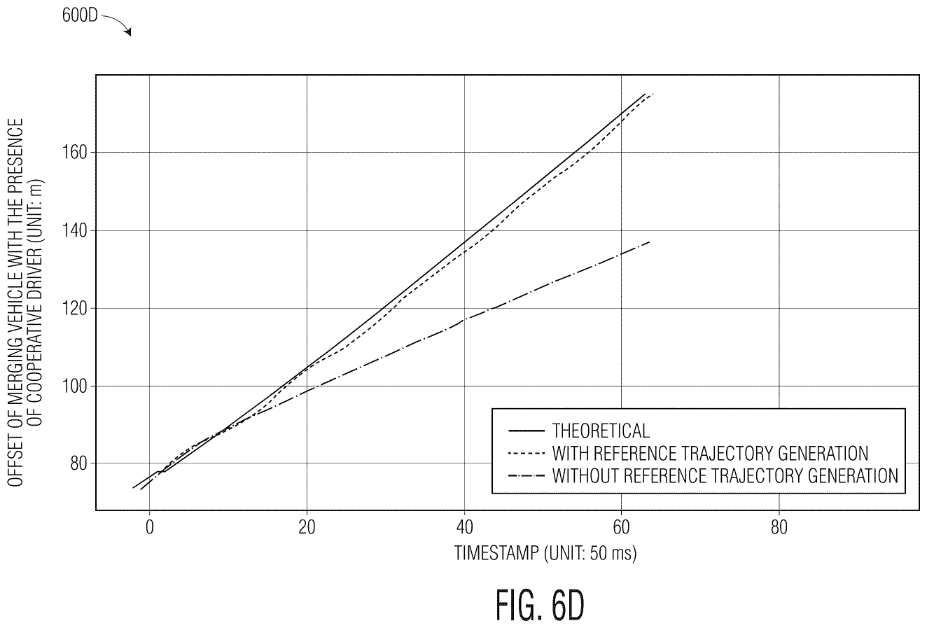

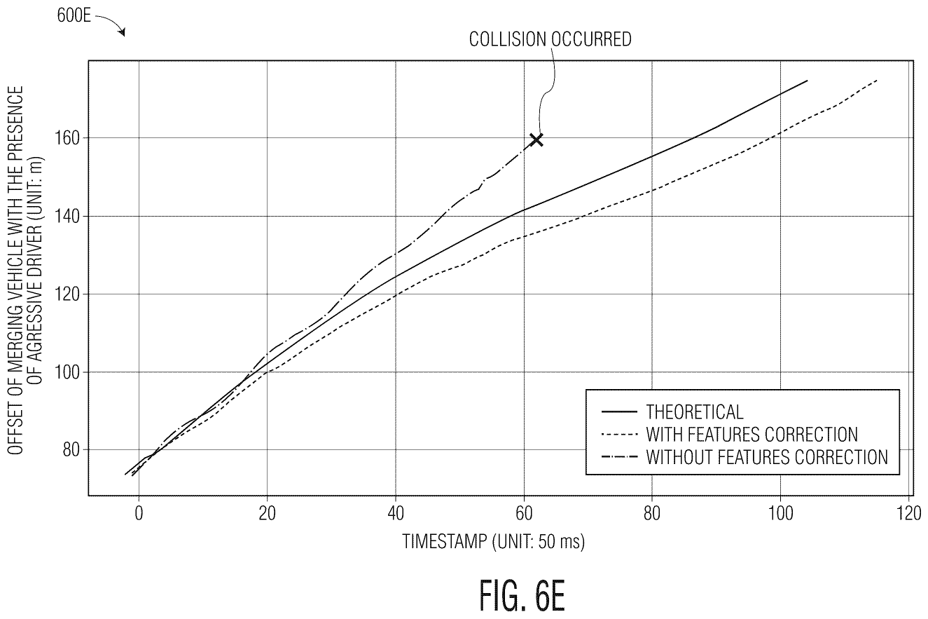

FIGS. 5 and 6A-6E illustrate a proof of concept for a 1:18 scale model experiment and simulation of a vehicle attempting to merge onto a highway. These figures demonstrate the system's functionality in a controlled, scaled-down environment, allowing for testing and validation of the proposed CAV control system. The 1:18 scale model provided a cost-effective and safe way to simulate real-world merging scenarios, evaluate the performance of the DIM and DRL algorithms, and assess the effectiveness of the MCM in guiding the CAV through complex merging maneuvers. This scaled approach may enable researchers to refine and optimize the system before implementing it in full-scale vehicles and real-world traffic situations.

Referring to FIG. 5, a proof of concept block diagram illustrates a system 500 for controlling CAVs using road infrastructure in a 1:18 scale model experiment and simulation. The system 500 may include sensors package 502 comprising a camera 502a and a lidar 502b. The camera 502a feeds into a YOLO module 504 for object detection, while the lidar 502b scaled-up its points cloud by a factor of 18 using multiplication module 508 (to compensate for the 1:18 scale of the model), and then connects to a clustering module 506.

In aspects, the YOLO module 504 uses the YOLOv5 framework to detect objects in the camera data. The YOLOv5 framework is an object detection algorithm that can accurately identify and locate objects in images. The clustering module 506 processes the lidar data to detect and cluster points that represent objects in the environment. The outputs from the YOLO module 504 and the clustering module 506 feed into a fusion module 510. The fusion module 510 combines the object detection results from the camera and lidar data to create a comprehensive representation of the environment.

The system 500 also may include a features extraction module 512 that extracts relevant features from the detected objects. These features may include, but are not limited to, the positions, sizes, and shapes of the detected objects. The extracted features may be then input to a DIM 516 and summation module 514. The DIM 516 may be a machine learning model that predicts the behavior of human drivers based on the extracted features. The output from the DIM 516 and the extracted features may be combined in summation module 514 and input to a DRL module 518.

The system 500 further may include a real-world dataset 522. This dataset 522 connects to a traffic generation module 524, which outputs to a summation module 526. The summation module 526 gathers reference trajectories for HDVs from the traffic generation module 524 and current state of CAV from the fusion module 510, and feeds into a simulator 528. The simulator 528 replicates the motion of the CAV and provides motions to HDVs. The simulator 528 may use a high-fidelity model of the vehicle dynamics and the road environment to accurately simulate the behavior of HDVs in the environment which are compared to their current states from the fusion module 510 through difference module 530.

The system 500 also may include communication module 520. The communication module 520 transmits actions from DRL to CAV and deviation of current HDVs state from reference trajectories provided by difference module 530.

The system 500 also may include two vehicle control modules. The first vehicle control module 532 (for merging vehicle 576) may include a communication module 534, path tracking module 536, a proportional-integral-derivative (PID) controller 538, and actuators 540 that output throttle command 542 and steering command 544. It also may include a road following module 546 with a ResNet 548, PID controller 550, and camera 552. The ResNet 548 is a deep learning model that may be used for road following in the 1:18 scale vehicles. The ResNet 548 takes the camera images as input, feeds to the PID controller 550 that outputs steering commands to keep the vehicle on the road.

The second vehicle control module 554 (for main lane vehicle 580) has a similar structure, including a communication module 556, path tracking module 558, PID controller 560, actuator 562 outputting throttle command 564 and steering command 566, and a road following module 568 with ResNet 570, PID controller 572, and camera 574. It is noted that these components are used for simulating human-driven behavior in the 1:18 scale model experiment. In real-world scenarios, the main lane vehicle 580 is expected to be manually driven. The inclusion of these control components in the model allows for more realistic emulation of human driving patterns and responses, enabling the system to test and validate its CAV control algorithms in a mixed traffic environment that closely resembles real-world conditions.

The diagram also depicts a merging vehicle 576 on a merge lane 578, and a main lane vehicle 580 on a main lane 582. These elements represent the real-world scenario that the system 500 may be designed to manage. The system 500 uses the sensor data, the machine learning models, and the vehicle control modules to control the merging vehicle 576 and ensure safe and efficient merging with the main lane traffic. It is noted that while this diagram shows two vehicles for illustrative purposes, the demonstration results presented in FIGS. 6B, 6C, 6D, and 6E are not limited to these two vehicles and may involve scenarios with multiple vehicles interacting in more complex traffic situations.

In aspects, the path tracking module 536, 558 may use path tracking data received by the V2X module 534, 556 from V2X module 520. The PID controller 538 may use a PID control algorithm to control the CAV vehicle's speed and/or steering based on the path tracking data and the control actions provided by the DRL module 518, while The PID controller 560 may use a PID control algorithm to control the HDVs' speed and/or steering based on the deviation of current HDVs state from reference trajectories provided by difference module 530. The actuators 540, 562 may include various types of actuators, such as motors, servos, or other types of actuators, to control the vehicle's throttle and steering based on the commands from the PID controller 538, 560.

In cases, the road following module 546, 568 may use a ResNet 548, 570 deep learning model to detect the road, and PID controller 550 and 572 to generate steering commands to keep the vehicle on the road. The ResNet 548, 570 may be trained using supervised learning methods on a dataset of road images. The camera 552, 574 may capture images of the road in front of the vehicle, which may be input to the ResNet 548, 570 to feed PID controllers 550 and 572 to generate the steering commands.

The communication modules 534 and 556 interfaces with the main system 500 to receive control instructions. The communication modules 534 and 556 may use various communication technologies, such as Wi-Fi, cellular networks, or DSRC, to communicate with the main system 500.

The 1:18 testbed may include a scaled-down roadway with various traffic scenarios, such as intersections, roundabouts, or highway on-ramps. The system 500 may use 1:18 scale Ackermann-steering vehicles with both longitudinal and lateral control for the tests. These vehicles may be equipped with the vehicle control modules described above, allowing them to autonomously navigate the testbed based on the control instructions from the main system 500.

Referring to FIG. 6A, a flowchart illustrates a proof-of-concept process 600A for controlling CAVs using roadside infrastructure in the 1:18 scale trial and simulation.

Referring to FIG. 6A, a flowchart illustrates a process 600A for controlling CAVs using roadside infrastructure in a 1:18 scale trial and simulation. The process 600A in FIG. 6A may include step 601 (collecting sensor data from roadside package), step 602 (sensor fusion), step 603 (extracting relevant features and inputting to DIM), step 604 (processing DIM output and features through other AI modules to generate speed and/or steering recommendation), step 605 (comparing fused sensor data with simulator output), step 606 (calculating position error), step 607 (transmitting speed and/or steering recommendation and position error to vehicles), and step 608 (model cars receiving and applying speed and/or steering recommendations).

In step 601 of FIG. 6A, sensor data may be collected from a roadside package. This may correspond to the sensors package 502 in FIG. 5, which may include a camera 502a and a lidar 502b. The camera 502a and lidar 502b may collect visual and distance information about the vehicles and the road environment in the 1:18 scale model.

Step 602 may involve sensor fusion, which may be performed by the fusion module 510 in FIG. 5. This module may combine the outputs from the YOLO module 504 (processing camera data) and the clustering module 506 (processing lidar data) to create a comprehensive representation of the environment.

In step 603, relevant features may be extracted from the fused data and input the DIM. This step may be performed by the features extraction module 512 and the DIM 516 in FIG. 5. The extracted features may include information about vehicle positions, sizes, and shapes, which the DIM uses to predict driver behavior.

Step 604 may involve processing the DIM output and features through other AI modules (DRL, features extraction, etc.) to generate a speed and/or steering recommendation for a merging vehicle. In FIG. 5, this may correspond to the operation of the summation module 514, which combines the DIM output with extracted features, and the subsequent processing by the DRL module 518.

In step 605, the fused sensor data is compared with simulator output. This comparison may be performed by the difference module 530 in FIG. 5, which receives inputs from both the simulator 528 and current HDVs states from the fusion module 510.

Step 606 may involve calculating a position error for emulation and test purposes based on the comparison from step 605 and speed recommendation from step 604. This calculation may also be part of the function of the difference module 530 in FIG. 5.

In step 607, the speed and/or steering recommendation and position error may be transmitted to vehicles. This transmission may be handled by the communication modules 534 and 556 in FIG. 5, which interface with the vehicle control modules for the merging vehicle 576 and main lane vehicle 580 respectively.

In step 608, model cars may receive and apply the speed and/or steering recommendations. In FIG. 5, this implementation may be carried out by the path tracking modules 536 and 558, PID controllers 538 and 560, and actuators 540 and 562, which translate the received recommendations into actual vehicle movements in the 1:18 scale model.

This process demonstrates how the various components of the system 500 in FIG. 5 work together to collect data, process it, generate recommendations, and control the model vehicles in the 1:18 scale trial and simulation. The process allows for testing and refinement of the CAV control algorithms in a controlled, scaled-down environment before implementation in full-scale vehicles.

In aspects, the process 600A may include additional or different steps. For example, the process 600A may include steps for handling different traffic scenarios, such as intersections or roundabouts. The process 600A may also include steps for handling different types of vehicles, such as trucks or motorcycles. The process 600A may further include steps for handling different road conditions, such as wet or icy roads.

Referring to FIG. 6B, a diagram 600B illustrates proof of concept trials for controlling CAVs using road infrastructure in a 1:18 scale trial and simulation, and a cooperative driver on the main lane. The diagram 600B is divided into two main sections: WITHOUT DIM AND DRL MODULES trial 610A and WITH DIM AND DRL MODULES trial 610B.

In the WITHOUT DIM AND DRL MODULES trial 610A, a rear end collision scenario 612 is depicted, where two vehicles collide due to the absence of the DRL and DIM systems. This scenario demonstrates the potential risks and challenges in controlling CAVs without the assistance of advanced machine learning models like DRL and DIM.

In contrast, the WITH DIM AND DRL MODULES trial 610B shows the operation of the system with the DRL and DIM models over three time intervals. The first time interval 614 shows the initial state at 0.9 seconds, where the DIM output is 0.0024 and the DRL recommends an acceleration of +3 m/s² for the merging CAV. This indicates that the DIM predicts a cooperative driver on the highway (likely to yield), and the system instructs the merging CAV to accelerate and merge in front of the highway vehicle.

The second time interval 616 occurs at 1.8 seconds, with the DIM output changing to 0.0013 and the DRL maintaining a constant speed (0 m/s² acceleration) for the merging CAV. This suggests that the DIM predicts the cooperative driver on the highway with higher confidence, and the system instructs the merging CAV to maintain its current speed.

The third time interval 618 shows the final state at 2.75 seconds, where the DIM output is 0.0015 and the DRL continues to maintain a constant speed for the merging CAV. This indicates that the DIM still predicts a cooperative driver on the highway, and the system instructs the merging CAV to continue maintaining its current speed to ensure safe merging.

At the bottom of the diagram, an output definition 620 explains the meaning of the DIM values. A DIM output of 0 indicates that the driver on the main highway has the intention to yield for the merging vehicle, while a DIM output of 1 indicates the driver on the main lane has the intention to not yield for the merging vehicle.

The diagram 600B demonstrates how the WITH DIM AND DRL MODULES system can prevent rear-end collisions by adjusting the CAV's behavior based on the predicted intentions of other drivers and the current traffic situation. This highlights the system's ability to improve safety and efficiency in complex traffic scenarios that are challenging for current onboard autonomous systems.

Referring to FIG. 6C, a diagram 600C illustrates proof of concept trials for controlling CAVs using road infrastructure in a 1:18 scale trial and simulation, and an aggressive driver on the main lane. The diagram 600C is divided into two main sections: WITHOUT DIM AND DRL MODULES trial 622A and WITH DIM AND DRL MODULES trial 622B.

In the WITHOUT DIM AND DRL MODULES trial 622A, a rear end collision scenario 624 is depicted, where two vehicles collide due to the absence of the DRL and DIM systems. This scenario demonstrates the potential risks and challenges in controlling CAVs without the assistance of advanced machine learning models like DRL and DIM.

In contrast, the WITH DIM AND DRL MODULES trial 622B shows the operation of the system with the DRL and DIM models over three time scenarios: a first time scenario 626, a second time scenario 628, and a third time scenario 630. Each scenario shows the positions of vehicles on a road and may include data on the DIM output and DRL recommendations.

In the first time scenario 626, occurring at 0.9 seconds, the DIM output is 0.7493, indicating a high probability that the driver on the main highway will not yield. The DRL recommends a deceleration of −5 m/s² for the merging vehicle.

The second time scenario 628, at 2.1 seconds, shows the DIM output increasing to 0.99, suggesting an even higher probability of the highway driver not yielding. The DRL maintains its recommendation for deceleration at −5 m/s².

In the third time scenario 630, at 3.95 seconds, the diagram shows the final positions of the vehicles after the merging maneuver, with the DIM output at 0 (yield) and the DRL recommending an acceleration of +3 m/s².

At the bottom of the diagram, an output definition 632 provides explanations for the DIM values: DIM=0 indicates the driver on the main highway has the intention to yield, while DIM=1 indicates the driver on the main lane has the intention to not yield for the merging vehicle.

The diagram 600C demonstrates how the WITH DIM AND DRL MODULES system adjusts its recommendations based on the predicted intentions of human drivers, potentially avoiding collisions and improving traffic flow in merging scenarios. This highlights the system's ability to improve safety and efficiency in complex traffic scenarios that are challenging for current onboard autonomous systems.

Referring to FIG. 6D, a graph 600D is presented that compares different trajectory generation methods for a vehicle in the proof of concept trials. The x-axis represents time in units of 100 milliseconds, ranging from 0 to 80. The y-axis represents the offset of the merging vehicle with the presence of cooperative driver in units of meters, ranging from 80 to 160. Three lines are plotted on the graph, each representing a different trajectory generation method.

The solid line represents the theoretical trajectory, which may be the ideal path that the vehicle should follow based on the planned trajectory generated by the reference trajectory generation module 324 (as shown in FIG. 3). This theoretical trajectory may be calculated based on the control actions provided by the DRL module 320 and the safe controller 322, and it represents the optimal path that the vehicle should follow for safe and efficient merging.

The dashed line represents a trajectory with reference trajectory generation, which may be the actual path followed by the vehicle when the reference trajectory generation module 324 is used. This trajectory may be generated by extrapolating the planned trajectory of the vehicle based on the control actions provided by the DRL module 320 and the safe controller 322. The reference trajectory generation module 324 compensates for uncertainties in vehicle dynamics models, control lags and helps address the “reinforcement learning transferability” problem when moving from simulated to real-world environments.

The dot-dash line represents a trajectory without reference trajectory generation, which may be the actual path followed by the vehicle when the reference trajectory generation module 324 is not used. This trajectory is generated based solely on the control actions provided by the DRL module 320 and the safe controller 322, without any compensation for uncertainties in vehicle dynamics models or the “reinforcement learning transferability” problem.

The graph 600D shows that the trajectory with reference trajectory generation closely follows the theoretical trajectory, indicating that the reference trajectory generation module 324 effectively compensates for uncertainties and helps the vehicle follow the optimal path. On the other hand, the trajectory without reference trajectory generation deviates significantly from the theoretical trajectory, indicating that without the reference trajectory generation module 324, the vehicle may not be able to accurately follow the optimal path.

Referring to FIG. 6E, a graph 600E is presented that compares different trajectory generation methods for a vehicle in the proof of concept trials. The x-axis represents time in units of 100 milliseconds, ranging from 0 to 80. The y-axis represents the merging vehicle offset with the presence of aggressive driver in units of meters, ranging from 80 to 160. Three lines are plotted on the graph, each representing a different trajectory generation method.

The solid line represents the theoretical trajectory, which may be the ideal path that the vehicle should follow based on the planned trajectory generated by the reference trajectory generation module 324 (as shown in FIG. 3). This theoretical trajectory may be calculated based on the control actions provided by the DRL module 320 and the safe controller 322, and it represents the optimal path that the vehicle should follow for safe and efficient merging.

The dashed line represents a trajectory with features correction, which may be the actual path followed by the vehicle when the features correction module 318 (as shown in FIG. 3) is used. This trajectory may be generated by adjusting the input features for the DIM 314 and DRL 320 models based on deviations between an actual state of the CAV and a desired reference trajectory. The features correction module 318 improves the robustness of the AI models' outputs by adding corrective terms to the extracted features.

The dot-dash line represents a trajectory without features correction, which may be the actual path followed by the vehicle when the features correction module 318 is not used. This trajectory may be generated based solely on the control actions provided by the DRL module 320 and the safe controller 322, without any compensation for uncertainties in vehicle dynamics models or the “reinforcement learning transferability” problem. The graph 600E shows that the trajectory with features correction reduces offset to compensate for the aggressive driver that does not yield.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the presented example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A system for controlling an autonomous vehicle using road infrastructure, comprising:
a plurality of sensors mounted on road infrastructure sensing information on a roadway;
a fusion module fusing the sensed information from the plurality of sensors to detect vehicles on the roadway;
a features extraction module extracting features from the detected vehicles;
a driver intention model (DIM) providing estimated driving behavior of manually driven vehicles of the detected vehicles based on the extracted features;
a deep reinforcement learning (DRL) module providing control actions for the autonomous vehicle based on the estimated driving behavior of the manually driven vehicles of the detected vehicles and based on the extracted features;
a reference trajectory generation module extrapolating planned trajectories of the autonomous vehicle based on the control actions; and
a V2X module for transmitting instructions to the autonomous vehicle based on the planned trajectories.

2. The system of claim 1, further comprising:
a safe controller for verifying the control actions provided by the DRL module against predefined safety rules;
a features correction module for compensating for errors in the extracted features based on a deviation between an actual state of the autonomous vehicle and the planned trajectories;
a recommendation calculator for calculating at least one of recommended speeds or recommended steering for the autonomous vehicle as part of the instructions.

3. The system of claim 2, wherein the features correction module adjusts the extracted features for the DIM and the DRL module based on deviations between an actual state of the autonomous vehicle and a desired reference trajectory, and wherein the adjustment comprises adding corrective terms to the extracted features.

4. The system of claim 1, wherein the DIM is trained using supervised or unsupervised learning to predict driver behaviors of the manually driven vehicles, and wherein the DIM outputs a probability indicating a likelihood of a highway driver yielding to a merging vehicle.

5. The system of claim 1, wherein the DRL module receives as input the extracted features and an output of the DIM, and generates recommended acceleration, deceleration or steering actions for the autonomous vehicle based on the inputs.

6. The system of claim 1, wherein the reference trajectory generation module compensates for uncertainties in vehicle dynamic models, lags in vehicle control and reinforcement learning transferability bias by extrapolating the planned trajectories according to the actions provided by the DRL and a safety controller.

7. The system of claim 1, further comprising a monitoring module for checking a state of traffic and selecting appropriate parameters for the DIM and the DRL module based on detected traffic conditions.

8. The system of claim 1, further comprising a speed and steering recommendation safety check module for monitoring whether the autonomous vehicle can track a provided reference trajectory, wherein the monitoring comprises comparing a current state of the autonomous vehicle to the reference trajectory at predetermined time intervals.

9. The system of claim 8, wherein the speed and steering recommendation safety check module generates a Minimum Risk Maneuver when a deviation between a state of the autonomous vehicle and a reference trajectory exceeds a predefined threshold, and wherein the Minimum Risk Maneuver comprises safe instructions for the autonomous vehicle to safely decelerate and pull over to a designated safe zone.

10. The system of claim 1, wherein the V2X module transmits Maneuver Coordination Messages containing the instructions comprising speed recommendations, steering recommendations, acceleration profiles, and anticipated merge points for the autonomous vehicle.

11. A method for controlling an autonomous vehicle using road infrastructure, comprising:
sensing information on a roadway using a plurality of sensors mounted on road infrastructure;
fusing the sensed information from the plurality of sensors to detect vehicles on the roadway;
extracting features from the detected vehicles;
providing estimated driving behavior of manually driven vehicles of the detected vehicles based on the extracted features using a driver intention model (DIM);
providing control actions for the autonomous vehicle based on the estimated driving behavior of the manually driven vehicles of the detected vehicles and based on the extracted features using a deep reinforcement learning (DRL) module;
extrapolating planned trajectories of the autonomous vehicle based on the control actions; and
transmitting instructions to the autonomous vehicle based on the planned trajectories using a V2X module.

12. The method of claim 11, further comprising:
verifying the control actions provided by the DRL module against predefined safety rules using a safe controller;
compensating for errors in the extracted features based on a deviation between an actual state of the autonomous vehicle and the planned trajectories using a features correction module; and
calculating at least one of recommended speeds or recommended steering for the autonomous vehicle as part of the instructions using a recommendation calculator.

13. The method of claim 12, wherein compensating for errors in the extracted features comprises adjusting the extracted features for the DIM and the DRL module based on deviations between an actual state of the autonomous vehicle and a desired reference trajectory, and wherein the adjustment comprises adding corrective terms to the extracted features.

14. The method of claim 11, wherein the DIM is trained using supervised or unsupervised learning to predict driver behaviors of the manually driven vehicles, and wherein the DIM outputs a probability indicating a likelihood of a highway driver yielding to a merging vehicle.

15. The method of claim 11, wherein the DRL module receives as input the extracted features and an output of the DIM, and generates recommended acceleration, deceleration or steering actions for the autonomous vehicle based on the inputs.

16. The method of claim 11, wherein extrapolating the planned trajectories comprises compensating for uncertainties in vehicle dynamic models, lags in vehicle control and reinforcement learning transferability bias by extrapolating the planned trajectories according to the actions provided by the DRL and a safety controller.

17. The method of claim 11, further comprising checking a state of traffic and selecting appropriate parameters for the DIM and the DRL module based on detected traffic conditions using a monitoring module.

18. The method of claim 11, further comprising monitoring whether the autonomous vehicle can track a provided reference trajectory using a speed and steering recommendation safety check module, wherein the monitoring comprises comparing a current state of the autonomous vehicle to the reference trajectory at predetermined time intervals.

19. The method of claim 18, further comprising generating a Minimum Risk Maneuver when a deviation between a state of the autonomous vehicle and a reference trajectory exceeds a predefined threshold using the speed and steering recommendation safety check module, and wherein the Minimum Risk Maneuver comprises safe instructions for the autonomous vehicle to safely decelerate and pull over to a designated safe zone.

20. The method of claim 11, wherein transmitting instructions comprises transmitting Maneuver Coordination Messages containing the instructions comprising speed recommendations, steering recommendations, acceleration profiles, and anticipated merge points for the autonomous vehicle.
